(19) United States
(12) Patent Application Publication
(10) Pub. No.: US 2026/0329959 A1
(43) Pub. Date: Oct. 22, 2026

(54) SYSTEM

(71) Applicant: SoftBank Group Corp., Tokyo (JP)

(72) Inventor: Keiko MIZUTA, Tokyo (JP)

(73) Assignee: SoftBank Group Corp., Tokyo (JP)

(21) Appl. No.: 19/649,139

(22) Filed: Apr. 16, 2026

(30) Foreign Application Priority Data
Apr. 22, 2025 (JP) 2025-070698

(51) Int. Cl. G06F 16/958; G06F 40/197; G06N 3/0475; G06V 10/44; G10L 15/26

(52) U.S. Cl. CPC G06F 16/958; G06F 40/197; G06N 3/0475; G06V 10/454; G10L 15/26

(57) ABSTRACT

The present invention relates to a system comprising a user input unit, an internal information acquisition unit, a generative AI processing unit, a draft presentation unit, an approval and reflection unit, and a backup management unit in order to streamline homepage update work without personalization, wherein based on desired content input by a user in a natural language, generative AI automatically generates a plurality of homepage update drafts while referring to internal past data and guidelines, the user selects a draft or gives a modification instruction, a final draft is automatically and safely reflected in an existing homepage, and a state before update is automatically saved, thereby realizing quick and high-quality homepage update by anyone even without specialized knowledge.

### CROSS-REFERENCE TO RELATED APPLICATION

The present application claims priority to and incorporates by reference the entire contents of Japanese Patent Application No. 2025-070698 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is a problem that, due to the fact that creation and update work of a homepage is managed in a person-dependent manner in a company or an organization, an update method, a program configuration, a design rule, operational know-how, and the like of the homepage are not handed over due to a personnel transfer or retirement of a person in charge, or a change of an outsourcing contractor, and as a result, a newly appointed person in charge cannot smoothly perform the update work of the homepage; a problem that it is difficult for a person in charge who does not have specialized knowledge of programs and markup languages to modify the content of the homepage, which causes a delay in information dissemination, posting of incorrect information, a decline in corporate image, and a significant decline in operational efficiency; a problem that internal assets such as past homepage-related programs, guidelines, and templates are not sufficiently utilized, similar work occurs repeatedly, and human resources and costs are wastefully consumed; a problem that, in a society where a declining birthrate, an aging population, and a human resource shortage are progressing, there is an urgent need to provide a mechanism capable of eliminating the personalization of homepage operation and allowing anyone to easily and safely perform the update work of the homepage; and a problem of enabling sustainable maintenance of the quality and brand image of the homepage by ensuring accuracy and immediacy of information while maintaining company-specific design rules, expression policies, and operational rules.

### SUMMARY OF THE INVENTION

As a means for solving the problem, a system is configured comprising a user input unit, an internal information acquisition unit, a generative AI processing unit, a draft presentation unit, an approval and reflection unit, and a backup management unit, wherein the user input unit receives desired update content of a homepage in a natural language, the internal information acquisition unit automatically acquires past homepage-related programs, update histories, design templates, guidelines, and related internal documents, the generative AI processing unit automatically generates a plurality of homepage update drafts using the desired content received from the user input unit and the information acquired by the internal information acquisition unit, the draft presentation unit presents the plurality of update drafts generated by the generative AI processing unit to a user, and receives a selection or a modification instruction by the user, the approval and reflection unit automatically reflects the update draft selected or modified by the user in an existing homepage file, the backup management unit automatically saves the homepage file before update to enable restoration, and by realizing a series of these processes using generative AI, personalization of homepage update work is eliminated, and even a person in charge who does not have specialized knowledge can quickly and safely realize the update of the homepage while maintaining company-specific rules and design policies.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

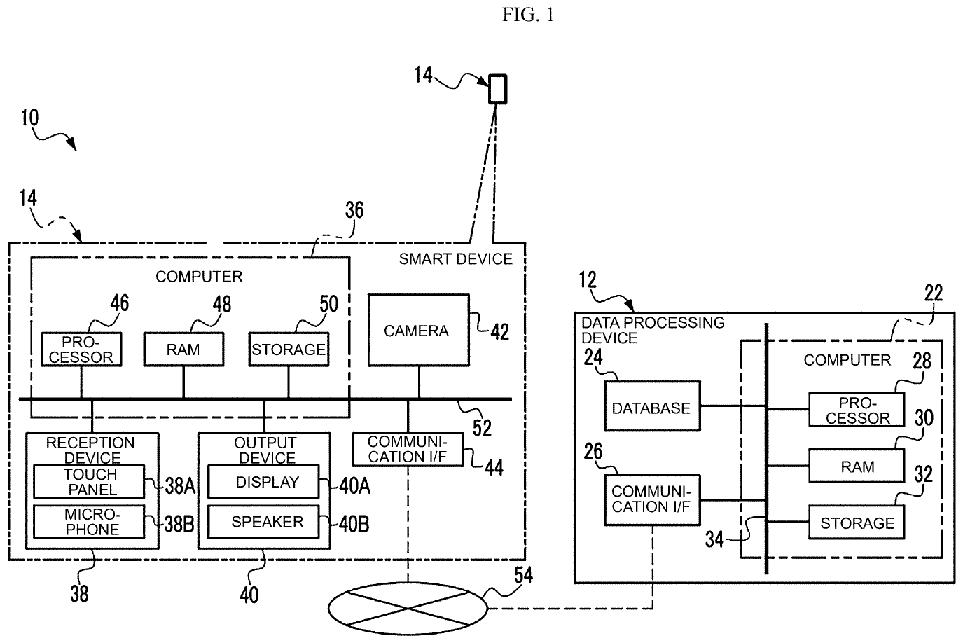

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

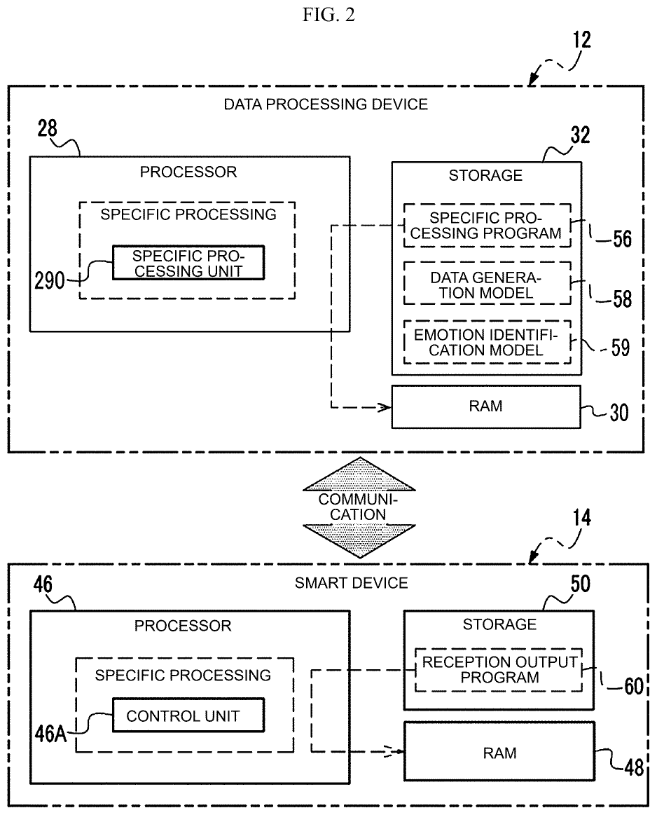

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment for carrying out the present invention, a homepage update support system is composed of a server and a terminal. The terminal is an information processing apparatus such as a personal computer, a tablet terminal, or a smartphone, and the server is a high-performance computer installed in a cloud environment or an on-premises environment, and includes various processing functions including generative AI. Specifically, the present system is a distributed processing system composed of a plurality of computing nodes. The present server includes a parallel computing cluster using GPUs. The present server is equipped with a tensor processing unit. The present server deploys a large language model on a memory. The present terminal and the present server are connected via a secure communication protocol. The present system distributes requests from users to each computing node by a load balancer. The present system distributes a processing load. The present system thereby improves a response speed. The present generative AI is a neural network adopting a transformer architecture. The present generative AI has billions of parameters. The present generative AI analyzes a context of input data using a self-attention mechanism. The present system operates as a containerized application on a virtual machine in a cloud environment. The present system automatically controls starting and stopping of containers using an orchestration tool. The present system dynamically scales computing resources according to an increase or decrease in traffic. The present system thereby optimizes utilization efficiency of hardware resources. The present system applies similar virtualization technology even in an on-premises environment. The present system processes highly confidential internal data without outputting it to an external network. The present system thereby reduces a risk of information leakage. The present system improves security of data management. The present system provides a technical improvement that maximizes parallel processing capability of a computer architecture, rather than mere automation of human work. The present system executes matrix operations in a high-dimensional space at high speed. The present system thereby realizes real-time homepage update support. The present system can be applied to EC site updates in the retail industry. The present system can be applied to corporate site management in the manufacturing industry. The present system can be applied to portal site operation of educational institutions.

First, a user input unit is implemented on the terminal side, and provides an interface for a person in charge of updating a homepage to input which part of the homepage is to be changed and how in a natural language. For example, various requests can be input in Japanese, such as “I want to change the greeting text on the top page to spring content,” “I want to add information on new product A,” “I want to replace the application guidelines in the recruitment information with the latest ones,” “I want to change the representative name in the company profile to a new person in charge,” and “I want to replace the access map image with a new map.” The input content is transmitted from the terminal to the server. The input interface can include various input means such as a text input field, voice input, image attachment, and file upload. For example, the person in charge can upload an image file saying, “I want to use this image for the banner on the top page.” Specifically, the present user input unit executes a graphical user interface program deployed on the memory of the terminal. The present user input unit monitors user operation events. The present user input unit acquires the input natural language text as a stream of character codes. The present user input unit inputs the acquired text stream into a natural language processing model. Input data to the present model is a one-dimensional array of token IDs obtained by dividing the text into subword units. The present input data is, for example, an integer vector with a maximum length of 1024 dimensions. The present input data undergoes normalization processing and special token addition processing as preprocessing. As a specific example of the present input data, numerical IDs corresponding to words such as “top page,” “greeting text,” “spring,” and “change” are included. As a specific example of the present input data, a special token indicating the start of a sentence is included. As a specific example of the present input data, a special token indicating the end of a sentence is included. Output data from the present model is a probability distribution of classification labels indicating the user's intention and structured data of extracted entities. The present output data includes an array of floating-point numbers from 0 to 1 for each intention category. As a specific example of the present output data, a character string “top page” indicating an update target is output. As a specific example of the present output data, a label “text replacement” indicating an update action is output. As a specific example of the present output data, a score “0.95” indicating the certainty of the intention is output. The present system uses this output result in a search query generation process for the subsequent internal information acquisition unit. The present system determines only an intention label whose probability score exceeds a predetermined threshold as a valid instruction. The present system executes a branching process to prompt the user to re-input if it is less than the threshold. In the case of voice input, the present user input unit digitally samples an analog voice signal acquired from a microphone. The present user input unit inputs digital voice data into an acoustic model to convert it into text. In the case of image attachment, the present user input unit converts an image file into a three-dimensional tensor of pixel values. The present user input unit inputs the image tensor into a convolutional neural network to extract a feature vector. The present system integrates these multimodal input data to analyze the user's intention with high accuracy. The present system thereby eliminates ambiguity of input. The present system improves intention extraction accuracy of a computer.

An internal information acquisition unit is implemented on the server side, and automatically searches for and acquires internal file servers and databases, past homepage-related programs, update histories, design templates, guidelines, operation manuals, past HTML, CSS, and JavaScript files, image materials, logo data, and further related documents such as past emails and meeting minutes. For example, it comprehensively collects a wide variety of internal assets, such as transitions of greeting texts on the top page in the past, posting formats of product information, description rules of recruitment information, brand colors and font specifications, layout templates, various banner images, operation guidelines for each department, compliance checklists created by a legal department, and expression tone manuals created by a public relations department. Furthermore, for example, meeting minutes and approval flows created when the homepage was updated in the past, email exchanges, design data delivered from an external contractor, API specifications of external services, and the like can also be targeted for acquisition. Specifically, the present internal information acquisition unit executes a crawler program that accesses a storage system of the server. The present internal information acquisition unit collects unstructured data from a plurality of data sources on an internal network. The present internal information acquisition unit inputs the collected text data into a natural language processing model. Input data to the present model is a one-dimensional array of text chunks extracted from documents. The present input data is, for example, a text segment divided every 512 tokens. The present input data undergoes HTML tag removal and noise character filtering processing as preprocessing. As a specific example of the present input data, paragraph text of a past greeting text is included. As a specific example of the present input data, text data of a product specification table is included. As a specific example of the present input data, bulleted text of a design guideline is included. Output data from the present model is a high-dimensional embedding vector expressing semantic features of each text chunk. The present output data is, for example, a one-dimensional array of 768-dimensional floating-point numbers. As a specific example of the present output data, a vector value indicating features of a greeting text is output. As a specific example of the present output data, a vector value indicating features of product information is output. As a specific example of the present output data, a vector value indicating constraints of a guideline is output. The present internal information acquisition unit stores this output result in a vector database. The present internal information acquisition unit calculates a cosine similarity between a query vector generated from the user's input and each vector in the database. The present internal information acquisition unit extracts documents with higher similarity scores as related information. The present internal information acquisition unit provides this extraction result as context information to the subsequent generative AI processing unit. The present internal information acquisition unit similarly extracts feature vectors for image data using an image recognition model. The present internal information acquisition unit indexes image vectors in the database. The present system realizes semantic search, which is impossible with conventional keyword matching search, by using vector operations in a high-dimensional space. The present system thereby dramatically improves search speed and extraction accuracy. The present system brings about an improvement in computer technology, which is efficiency of data management. The present system can be applied to compliance document search in financial institutions. The present system can be applied to past medical record information search in medical institutions.

A generative AI processing unit is implemented on the server side, receives desired content in a natural language transmitted from the user input unit and various internal assets acquired by the internal information acquisition unit as input information, and automatically generates a plurality of homepage update drafts by combining generative AI, for example, a large language model, image generation AI, code generation AI, layout optimization AI, expression tone determination AI, and the like. For example, in response to a request to change the greeting text on the top page to spring content, it automatically generates a plurality of candidate sentences such as “Greetings for the new fiscal year,” “Welcoming the cherry blossom season,” and “Information on new spring products” while referring to expressions of past greeting texts and internal tone and manners. Furthermore, spring-like image images and banner images can also be automatically generated using the image generation AI. For example, it generates a plurality of image drafts such as “a background image with fluttering cherry blossom petals,” “a banner imaging fresh greenery,” and “an image with a catchphrase supporting a new life in spring.” In the case of adding product information, it refers to posting formats and expression rules of past product information, and automatically generates specified new product information (for example, product name, model number, specifications, price, release date, features, image, catalog PDF, etc.) with an appropriate layout and design. For example, it automatically incorporates detailed elements such as “adding information on new product A in accordance with the layout of the existing product list page,” “emphasizing features of the new product with bullet points,” “automatically resizing and posting a product image,” and “automatically generating a link button to a catalog PDF.” In the case of updating recruitment information, it receives the latest application guidelines (job type, work location, salary, application qualifications, selection flow, entry form URL, etc.) as input, and automatically generates HTML and CSS codes reflecting the latest information while following the configuration and expressions of past recruitment pages. For example, it incorporates practical elements such as “displaying in a card-type layout for each job type,” “placing a link button to an entry form in a prominent position,” and “diverting past expressions to an application qualification column.” Specifically, the present generative AI processing unit executes a pipeline integrating a plurality of neural network models. The present generative AI processing unit inputs a prompt to the large language model. Input data to the present model is a one-dimensional array of token IDs obtained by combining the user's request text and the context text extracted by the internal information acquisition unit. The present input data is, for example, an integer vector with a maximum length of 4096 dimensions. The present input data undergoes system prompt addition and tokenization processing as preprocessing. As a specific example of the present input data, an instruction token “Create a greeting text according to the following guidelines” is included. As a specific example of the present input data, an example token of a past greeting text is included. As a specific example of the present input data, a request token “change to spring content” of the user is included. Output data from the present model is a sequence of token IDs of the generated text and a generation probability of each token. The present output data is time-series data of a probability distribution vector of a vocabulary size dimension. As a specific example of the present output data, a token “for the new fiscal year” is output. As a specific example of the present output data, a token “Greetings” is output. As a specific example of the present output data, a numerical value “0.99” indicating the generation probability of each token is output. The present generative AI processing unit converts this output result into a human-readable text character string using a decoder. The present generative AI processing unit passes the generated text to a subsequent HTML generation module. The present generative AI processing unit executes a diffusion model as the image generation AI. Input data to the present diffusion model is a conditioning vector encoding an explanatory text of an image to be generated and a three-dimensional tensor of random noise. The present input data is, for example, a 64×64×4-dimensional latent variable tensor. As a specific example of the present input data, a text feature vector instructing a cherry blossom landscape is included. As a specific example of the present input data, an initial noise tensor sampled from a normal distribution is included. Output data from the present diffusion model is a three-dimensional tensor of pixel values of an image from which noise has been removed. The present output data is, for example, a 512×512×3-dimensional RGB image tensor. As a specific example of the present output data, a numerical array indicating red pixel intensity is output. As a specific example of the present output data, a numerical array indicating green pixel intensity is output. As a specific example of the present output data, a numerical array indicating blue pixel intensity is output. The present generative AI processing unit encodes this output result as an image file and passes it to the subsequent draft presentation unit. The present system directly generates syntax trees of HTML and CSS using the code generation AI. The present system thereby generates accurate codes without syntax errors at high speed. The present system optimizes a design using a probabilistic generation algorithm different from a human mental process. The present system thereby improves calculation efficiency.

A draft presentation unit is implemented on the terminal side, and presents the plurality of homepage update drafts generated by the generative AI processing unit to the user as preview images or HTML files. For example, it displays three drafts of greeting texts and preview images of the top page corresponding to each side by side so that the user can intuitively compare and select them. In the case of adding product information, it displays a plurality of previews of the product list page after addition, and differences in layout and design can be confirmed. In the case of updating recruitment information, it presents a plurality of drafts such as a display method for each job type and an arrangement pattern of application buttons. The user can select a draft that best matches the desired content, or input a more detailed modification instruction in a natural language. For example, additional requests can be input, such as “I want the greeting text of this draft to be a slightly more casual expression,” “I want an illustration of cherry blossoms added to the banner image,” “I want the feature column of the product information to be bold,” and “I want the color of the application button to match the brand color.” These additional instructions are also transmitted again to the generative AI processing unit on the server side, and a modified version of the draft is regenerated. Furthermore, for example, even when the user additionally uploads a file such as an image or a PDF, the AI automatically performs optimal layout and link settings and reflects them in the draft. Specifically, the present draft presentation unit executes a rendering engine using a processor of the terminal. The present draft presentation unit deploys the HTML codes and image data received from the generative AI processing unit on the memory. The present draft presentation unit constructs a document object model tree from the received data. The present draft presentation unit executes pixel drawing processing on a screen based on the constructed tree. The present draft presentation unit renders the plurality of update drafts in parallel. The present draft presentation unit executes a natural language processing module that receives an additional instruction from the user. Input data to the present module is a text stream of the modification instruction input by the user. The present input data is a one-dimensional array of character codes. The present input data undergoes morphological analysis and vectorization processing as preprocessing. As a specific example of the present input data, a character string vector “casual expression” is included. As a specific example of the present input data, a character string vector “illustration of cherry blossoms” is included. As a specific example of the present input data, a character string vector “bold” is included. Output data from the present module is a feature vector indicating a modification intention and specific information of a target element. The present output data is a multidimensional floating-point number array. As a specific example of the present output data, a classification code instructing a change in text style is output. As a specific example of the present output data, an ID of an HTML element to be changed is output. As a specific example of the present output data, a weight parameter indicating the strength of modification is output. The present system transmits this output result as feedback to the generative AI processing unit on the server side. The present system dynamically rewrites a prompt of a generative model using a feedback vector. The present system differentially renders only a changed portion using a virtual document object model. The present system thereby improves a screen redrawing speed. The present system reduces a network communication amount. The present system constructs an interactive processing loop that accurately reflects the user's intention. The present system can be applied to a creative production process of an advertising agency. The present system can be applied to web magazine editing work of a publishing company.

An approval and reflection unit is implemented on the server side, and automatically reflects the update draft finally approved by the user in an existing homepage file. Specifically, the generative AI analyzes existing HTML, CSS, and JavaScript files to safely and accurately rewrite only a specified portion. For example, it automatically executes partial updates, such as replacing only a text portion of a greeting text with new content, adding a new product item to a product information list, updating a recruitment information table to the latest content, replacing a banner image with a new one, newly adding a link to a PDF file, adding a link to a new page in a navigation menu, and updating company information in a footer to the latest one. Furthermore, the AI automatically checks consistency of links and navigation across a plurality of pages, and modifies related pages as necessary. For example, when a new product is added to a product information page, a link and an introductory text can be automatically added to a top page, a news page, and a related product page. Specifically, the present approval and reflection unit executes a file update transaction using a processor of the server. The present approval and reflection unit reads an existing HTML file and generates an abstract syntax tree. The present approval and reflection unit compares an abstract syntax tree of the update draft output by the generative AI with the existing abstract syntax tree. The present approval and reflection unit executes an algorithm for extracting a difference between the two. The present approval and reflection unit uses a graph neural network for this difference extraction processing. Input data to the present network is graph structure data having HTML elements as nodes and parent-child relationships as edges. The present input data is a set of feature vectors of nodes and an adjacency matrix. The present input data undergoes vectorization processing of tag names and attribute values of each node as preprocessing. As a specific example of the present input data, a node vector indicating a div tag is included. As a specific example of the present input data, a feature vector indicating a class attribute is included. As a specific example of the present input data, a binary matrix indicating connection relationships between nodes is included. Output data from the present network is an array of probability scores indicating necessity of updating each node. The present output data is a floating-point number from 0 to 1 for each node. As a specific example of the present output data, an update score “0.99” for a greeting text node is output. As a specific example of the present output data, a non-update score “0.01” for a header node is output. As a specific example of the present output data, an insertion position index of a newly added product node is output. The present approval and reflection unit executes node replacement, addition, and deletion processing of the abstract syntax tree based on this output result. The present approval and reflection unit serializes the updated abstract syntax tree into an HTML character string again. The present approval and reflection unit executes a crawler that verifies link consistency among a plurality of pages. The present approval and reflection unit automatically modifies a path when detecting a broken link. The present system executes these processes as an atomic transaction. The present system automatically rolls back when an error occurs during processing. The present system thereby strictly ensures data consistency. The present system eliminates manual code editing errors and improves reliability of a computer system. The present system can be applied to automatic updating of a large-scale portal site. The present system can be applied to integrated site management of a corporate group across a plurality of domains.

A backup management unit is implemented on the server side, and automatically saves a current set of homepage files as a backup before executing an update operation. For example, it saves all related files constituting the homepage, such as HTML files, CSS files, JavaScript files, image files, PDF materials, video files, and setting files for external service linkage, with time information, and performs past version management. Thereby, even if a defect occurs after an update, it can be restored to an original state with one click in an emergency. Furthermore, it records all update histories so that who made what changes and when can be confirmed from a management screen. For example, detailed histories such as “Apr.1, 2024 10:00 Top page greeting text update,” “Apr. 2, 2024 15:30 Product information addition,” and “Apr. 3, 2024 9:00 Recruitment information modification” can be displayed in chronological order. Specifically, the present backup management unit controls a storage controller of the server to execute data preservation processing. The present backup management unit applies a hash function to a group of files to be updated. The present backup management unit calculates a unique hash value of each file. The present backup management unit detects a change in file content using the calculated hash value. The present backup management unit saves only a file in which a change is detected in a storage as a differential backup. The present backup management unit applies a data compression algorithm to this processing. Input data to the present backup management unit is a binary data stream to be saved. The present input data is a one-dimensional array of byte sequences. The present input data undergoes chunk division processing as preprocessing. As a specific example of the present input data, a text byte sequence of an HTML file is included. As a specific example of the present input data, binary data of an image file is included. As a specific example of the present input data, encoded data of a PDF file is included. Output data from the present backup management unit is a compressed archive file and a structured record of metadata. The present output data is a binary block written to the storage. As a specific example of the present output data, a data block compressed by an LZ77 algorithm is output. As a specific example of the present output data, metadata in a JSON format including a time stamp is output. As a specific example of the present output data, a log record including an identifier of an updater is output. The present backup management unit duplicates and saves this output result in a distributed storage system. The present backup management unit indexes metadata using a time-series database. When receiving a restoration request from the user, the present system searches for metadata of a specified time stamp. The present system decompresses a corresponding archive file and overwrites and deploys it to an original file path. The present system significantly reduces storage capacity by using deduplication technology. The present system improves a history search speed by utilizing an in-memory database. The present system thereby improves data management efficiency of a computer. The present system can be applied to audit log saving of a financial system. The present system can be applied to an official document management system of a public institution.

In this embodiment, the generative AI plays a core role in the system, and plays an indispensable role in all main processes, such as analysis of requests in a natural language, automatic reading of internal assets, automatic generation of homepage update drafts, code generation of HTML, CSS, and the like, automatic generation of images and banners, difference analysis and safe rewriting of existing files, automatic modification of related pages, and flexible response to additional instructions from users. For example, the generative AI automatically and rapidly executes operations such as complex HTML editing, design adjustment, guideline compliance check, image creation, and link consistency confirmation, which were conventionally performed manually by a person in charge having specialized knowledge, thereby eliminating personalization and enabling anyone to easily realize high-quality homepage updates. Specifically, the present generative AI is a complex neural network system composed of a plurality of modules. The present generative AI includes a multimodal model that integrally processes a natural language processing task and a computer vision task. Input data to the present model is a complex data structure combining an array of text tokens and a tensor of image patches. The present input data is, for example, a high-dimensional vector obtained by projecting a one-dimensional vector for text and a three-dimensional tensor for images into the same latent space. The present input data undergoes feature amount fusion processing by a cross-attention mechanism as preprocessing. As a specific example of the present input data, an embedding vector of the user's request text is included. As a specific example of the present input data, an embedding vector of a screenshot image of an existing homepage is included. As a specific example of the present input data, a text vector of an internal guideline is included. Output data from the present model is structured data in a JSON format defining a structure of the homepage after update and a group of generated asset files. The present output data is a set of key-value pairs including properties of each element. As a specific example of the present output data, a numerical array indicating grid coordinates of a new layout is output. As a specific example of the present output data, a character string of generated text content is output. As a specific example of the present output data, a list of CSS class names to be applied is output. The present system inputs this output result to a subsequent code generator to synthesize a final HTML file. The present generative AI has weight parameters pre-trained by self-supervised learning. The present generative AI undergoes fine-tuning processing to adapt to coding conventions of a specific company. The present system updates weights so as to minimize a loss function using a gradient descent method. The present system thereby improves generation accuracy in a specific domain. The present system replaces heuristic judgments made by human experts with mathematical optimization problems. The present system thereby brings about technical effects of speeding up processing and uniforming quality. The present system can be applied to automatic coding support in software development. The present system can be applied to automatic generation of landing pages in digital marketing.

Also, for example, even when a company-specific brand image and design rules are strictly defined, the generative AI learns past internal documents and design templates, and generates an update draft automatically reflecting them, so that damage to the brand image and deviation from the rules can be prevented. For example, even when a specific color scheme, font, logo arrangement, expression tone, and the like are specified, the AI automatically generates a draft complying with them. Furthermore, for example, even when a plurality of departments jointly operate a homepage, the AI can refer to past update histories and guidelines of each department, and individually generate a draft in line with operation rules for each department. For example, it is also possible to automatically refer to a compliance checklist created by a legal department, and the AI automatically detects a portion having a legal risk in expression and presents a modification draft. It is also possible to refer to an expression tone manual created by a public relations department, and the AI automatically determines whether an expression for outside the company is appropriate, and modifies it as necessary. Specifically, the present generative AI adopts a hybrid architecture combining a rule-based constraint engine and a neural network. The present generative AI executes a classification model as expression tone determination AI. Input data to the present classification model is a token array of generated text candidates and a condition vector of a guideline. The present input data is, for example, a combined tensor of a 768-dimensional text embedding vector and a 256-dimensional constraint vector. The present input data undergoes normalization and dimensionality reduction processing as preprocessing. As a specific example of the present input data, a text vector of a generated greeting text is included. As a specific example of the present input data, a vector representation of a prohibited word list specified by the legal department is included. As a specific example of the present input data, a numerical vector indicating RGB values of a brand color is included. Output data from the present classification model is an array of violation probability scores for each compliance item. The present output data is a list of floating-point numbers from 0 to 1. As a specific example of the present output data, a score “0.05” indicating a copyright infringement risk is output. As a specific example of the present output data, a score “0.12” indicating a brand tone deviation risk is output. As a specific example of the present output data, a score “0.01” indicating an inappropriate expression risk is output. The present system passes this output result to a subsequent filtering processing module. The present system automatically discards a candidate whose probability score exceeds a preset safety threshold. The present system presents only safe candidates equal to or less than the threshold to the user. The present system inputs RGB values of a specified color palette as a conditioning vector to a diffusion model also in image generation. The present system thereby mathematically constrains pixel values of a generated image to fall within an allowable range of a brand color. The present system replaces brand management, which relied on human visual confirmation, with an automatic determination algorithm of a computer. The present system thereby eliminates a bottleneck of checking work and improves a processing speed. The present system can be applied to a strict examination process of a medical information provision site of a pharmaceutical company. The present system can be applied to unified brand management of each store site of a franchise chain.

Furthermore, for example, when multilingual support of a homepage is required, the generative AI can also automatically generate pages in a plurality of languages such as English, Chinese, and Korean based on a request input in Japanese. For example, in response to a request “I want new product information to be reflected on an English page as well,” the AI automatically translates it, and can add the new product information in accordance with a layout and expression rules of an existing English page. Furthermore, for example, when accessibility support is required, the AI can automatically add an alt attribute and an aria label to enhance voice reading support for visually impaired persons. Specifically, the present generative AI executes an encoder-decoder type machine translation neural network for multilingual support. Input data to the present translation network is a Japanese text token array and a control vector specifying a target language. The present input data is, for example, an integer vector with a maximum length of 1024 dimensions. The present input data undergoes language-specific subword division processing as preprocessing. As a specific example of the present input data, a Japanese token “new product” is included. As a specific example of the present input data, a one-hot vector specifying “English” is included. As a specific example of the present input data, a token of peripheral text for maintaining context is included. Output data from the present translation network is a text token array of the target language and an attention weight matrix of each token. The present output data is time-series data of a probability distribution of a vocabulary size dimension. As a specific example of the present output data, an English token “New” is output. As a specific example of the present output data, an English token “Product” is output. As a specific example of the present output data, a two-dimensional array of attention scores indicating a correspondence relationship with original text is output. The present system inserts translated text into an appropriate node of HTML using this output result. The present system executes an image caption generation model for accessibility support. Input data to the present model is a pixel tensor of an image file. The present input data is, for example, a 224×224×3-dimensional normalized image tensor. As a specific example of the present input data, an RGB array of a product image is included. As a specific example of the present input data, pixel data of a banner image is included. As a specific example of the present input data, a tensor of a graph image is included. Output data from the present model is a text token array explaining content of an image. As a specific example of the present output data, text “a new product smartphone placed on a blue background” is output. The present system automatically writes this output result into a document object model as an alt attribute value of HTML. The present system thereby reduces calculation costs for multilingualization and accessibility support. The present system can be applied to multilingual corporate site operation of a global company. The present system can be applied to barrier-free website construction of a public institution.

Further, for example, when cooperation with an external service is necessary, the generative AI can automatically analyze an API specification of the external service and add a new API cooperation function to the homepage. For example, in response to a request “I want to display the latest SNS posts on the top page,” the AI can refer to the API specification of the SNS, automatically generate necessary JavaScript codes and embedded tags, and incorporate them into the homepage. Specifically, the generative AI executes an API specification analysis module and a code generation model for external service cooperation. Input data to the analysis module is text data of an OpenAPI specification described in a JSON or YAML format. The input data is a hierarchical data structure parsed as a syntax tree. The input data undergoes extraction processing of an endpoint, a method, and a parameter as preprocessing. As a specific example of the input data, a character string of a “GET” method is included. As a specific example of the input data, an endpoint URL “/api/v1/posts” is included. As a specific example of the input data, a definition of header information requesting an authentication key is included. Output data from the analysis module is a structured list of parameters necessary for an API call and a vector representation of constraint conditions. As a specific example of the output data, a key name of an essential parameter is output. As a specific example of the output data, designation information of a data type is output. As a specific example of the output data, numerical information of a rate limit is output. The system combines the output result and the user's request text and inputs them to the code generation model. Output data from the code generation model is an abstract syntax tree of an executable JavaScript code. As a specific example of the output data, a code block of asynchronous processing calling a fetch function is output. As a specific example of the output data, a code of a rendering function that binds acquired JSON data to an HTML element is output. As a specific example of the output data, a code of a try-catch block for error handling is output. The system test-executes the output result in a sandbox environment. The system embeds the output result as a script tag in a production HTML file after confirming that no runtime error occurs. The system thereby eliminates manual coding work. The system reduces implementation errors of external API cooperation and improves system stability. The system can be applied to a regional portal site using a weather forecast API. The system can be applied to an EC site integrating a payment gateway API.

As described above, according to the embodiment of the present invention, the personalization of homepage update work is eliminated, and even a person in charge without specialized knowledge can quickly and safely realize a homepage update while maintaining company-specific rules and design policies. In addition, by utilizing generative AI, complicated manual work and human errors in the related art can be significantly reduced, and immediacy and accuracy of information dissemination, maintenance of a brand image, improvement of business efficiency, and optimization of human resources can be achieved at the same time. Furthermore, a backup and history management function can provide a robust operation infrastructure capable of quickly responding to an emergency. In addition, it is possible to flexibly respond to various requirements required for modern homepage operation, such as multilingual support, accessibility support, and external service cooperation, and it is possible to realize a system with high future expandability and high connectivity with other systems. Specifically, the system is implemented as a distributed computing system adopting a microservice architecture. The system deploys each functional module as an independent container. The system dynamically optimizes resource allocation of each container using a container orchestration platform. The system controls asynchronous communication between modules via an API gateway. The system attempts to make processing asynchronous using a message queue. The system thereby prevents load concentration on a specific module. The system reduces latency of the entire system. The system utilizes a hardware accelerator dedicated to tensor calculation in inference processing of the generative AI. The system reduces memory usage using a model quantization technique. The system thereby improves an inference speed. The system shards and saves backup data and history logs in a distributed database. The system thereby improves a data access speed. The system is not merely a tool for improving business efficiency, but a fundamental improvement of computer technology that realizes efficient use of hardware resources, optimization of a network bandwidth, and speeding up of data processing. The system does not imitate a human mental process, but solves a problem using an unconventional method peculiar to a computer, such as calculation in a high-dimensional vector space and a probabilistic generation algorithm. The system thereby ensures the immediacy and accuracy of information dissemination. The system provides a robust infrastructure that can be easily scaled out even for a future traffic increase. The system can be applied to a content management system of a large-scale media site. The system can be applied to an integrated web platform of an apparel company developing a plurality of brands. The system can be applied to a real-time disaster prevention information distribution system of a local government.

### System Configuration

The system according to the present embodiment comprises a user input unit, an internal information acquisition unit, a generative AI processing unit, a draft presentation unit, an approval and reflection unit, and a backup management unit. The user input unit is a unit configured to provide an interface for a person in charge of updating a homepage to input which part of the homepage is to be changed and how in a natural language, operates on a terminal such as a personal computer, a tablet terminal, or a smartphone, for example, and includes various input means such as a text input field, a voice input function, an image attachment function, and a file upload function. Specifically, various requests can be input in Japanese or instructed by voice, such as “I want to change the greeting text on the top page to spring content,” “I want to add information on new product B,” “I want to replace the application guidelines in the recruitment information with the latest ones,” “I want to change the representative name in the company overview to a new person in charge,” “I want to replace the image of the access map with a new map,” and “I want to use this image for the banner on the top page.” The user input unit transmits the input content to a server in real time, and can also perform a typographical error check of the input content, automatic completion of the input content, presentation of an input example according to the input content, and the like. Specifically, the user input unit is implemented as a front-end application operating on a processor of the terminal. The user input unit captures a user's keystroke event in real time. The user input unit transmits the captured input stream to the server using an asynchronous communication protocol. The user input unit executes a recurrent neural network for automatic completion of the input content. Input data to the network is a character code sequence of text being input by the user. The input data is, for example, a two-dimensional tensor obtained by one-hot encoding the latest 50 characters. The input data undergoes a padding process as a preprocessing. As a specific example of the input data, a tensor representation of a character string “greeting t on the top page” is included. As a specific example of the input data, a tensor representation of a character string “of the new product” is included. As a specific example of the input data, a tensor representation of a character string “recruitment” is included. Output data from the network is a probability distribution vector of a word having a high possibility of appearing next. The output data is a floating-point number array of a vocabulary size dimension. As a specific example of the output data, a high probability score for a word “ext” is output. As a specific example of the output data, a high probability score for a word “information” is output. As a specific example of the output data, a high probability score for a word “person in charge” is output. The user input unit uses this output result to pop up and display suggest candidates on a screen. In the voice input function, the user input unit converts voice waveform data acquired from a microphone into a spectrogram image by a short-time Fourier transform. The user input unit inputs this spectrogram to a convolutional neural network to extract an acoustic feature amount. The system physically reduces a user's input load by these processes. The system prevents an input error in advance and improves accuracy of subsequent natural language processing. The system can be applied to an input interface in an operator support system of a call center. The system can be applied to a voice assistant application of a smartphone.

The internal information acquisition unit is a unit implemented on the server side and configured to automatically search for and acquire all internal assets related to homepage operation, such as internal file servers and databases, past homepage-related programs, update histories, design templates, guidelines, operation manuals, HTML files, CSS files, JavaScript files, image materials, logo data, meeting minutes, emails, design data delivered from an external contractor, and API specifications of an external service. For example, it collects transitions of greeting texts on the top page in the past in chronological order, extracts posting formats and expression rules of product information, organizes description rules of recruitment information and past application guidelines, and comprehensively collects brand colors and font specifications, layout templates, various banner images, operation guidelines for each department, a compliance checklist created by a legal department, an expression tone manual created by a public relations department, and the like. Furthermore, meeting minutes and approval flows created when the homepage was updated in the past, email exchanges, design data delivered from an external contractor, API specifications of an external service, and the like are also targeted for acquisition, and this information is provided to the generative AI processing unit. Specifically, the internal information acquisition unit executes a data collection daemon resident as a background process of the server. The internal information acquisition unit periodically polls various internal data sources. The internal information acquisition unit detects and acquires a newly added or updated file. The internal information acquisition unit executes a parser that normalizes the acquired files of various formats into plain text. The internal information acquisition unit inputs the normalized text to an embedding model. Input data to the model is a one-dimensional array obtained by dividing the text into a fixed-length token sequence. The input data is, for example, a 512-dimensional integer vector. The input data undergoes stop word removal and lowercasing processes as a preprocessing. As a specific example of the input data, text of a decision matter in the meeting minutes is included. As a specific example of the input data, text of a layer name of the design data is included. As a specific example of the input data, an endpoint explanatory text of the API specification is included. Output data from the model is a dense vector capturing a semantic representation of the input text. The output data is, for example, a 1024-dimensional floating-point number array. As a specific example of the output data, a vector value indicating a context of the meeting minutes is output. As a specific example of the output data, a vector value indicating an intention of the design is output. As a specific example of the output data, a vector value indicating a function of the API is output. The internal information acquisition unit indexes this output result in a vector database implementing an approximate nearest neighbor search algorithm. The internal information acquisition unit constructs an index using a hierarchical navigable small world graph. Thereby, the system searches for related information from among millions of internal documents in milliseconds. The system breaks through a limit of an exact match search using a conventional RDBMS and significantly reduces a calculation cost of the search. The system can be applied to a past precedent search system of a law firm. The system can be applied to a paper database search of a research institution.

The generative AI processing unit is a unit implemented on the server side and configured to receive the desired content in the natural language transmitted from the user input unit and the various internal assets acquired by the internal information acquisition unit as input information, and automatically generate a plurality of homepage update drafts by combining generative AI, that is, a large language model, image generation AI, code generation AI, layout optimization AI, expression tone determination AI, and the like. For example, in response to a request to change the greeting text on the top page to spring content, it automatically generates a plurality of candidate texts such as “Greetings for the new fiscal year,” “Welcoming the cherry blossom season,” and “Information on new spring products” while referring to expressions of past greeting texts and internal tones and manners. Using the image generation AI, spring-like image images and banner images can also be automatically generated. For example, it generates a plurality of image drafts such as “a background image with fluttering cherry blossom petals,” “a banner imaging fresh greenery,” and “an image with a catchphrase supporting a new life in spring.” In the case of adding product information, it refers to posting formats and expression rules of past product information, and automatically generates specified new product information (product name, model number, specifications, price, release date, features, image, catalog PDF, etc.) with an appropriate layout and design. For example, it automatically incorporates detailed elements such as “adding information on new product B in accordance with a layout of an existing product list page,” “emphasizing features of the new product with bullet points,” “automatically resizing and posting a product image,” and “automatically generating a link button to a catalog PDF.” In the case of updating recruitment information, it receives the latest application guidelines (job category, work location, salary, application qualifications, selection flow, entry form URL, etc.) as input, and automatically generates HTML and CSS codes reflecting the latest information while following a configuration and expressions of a past recruitment page. For example, it incorporates practical elements such as “displaying in a card-type layout for each recruitment job category,” “arranging a link button to an entry form at a conspicuous position,” and “diverting past expressions to an application qualification column.” Specific examples of a prompt text to be read by the generative AI include “Please change the greeting text on the top page to spring content. Please maintain the tone of the past greeting texts and incorporate an image of cherry blossoms,” “Please add the information on new product B to the product list page. Please include the product name, model number, specifications, price, release date, features, image, and link to the catalog PDF in accordance with the posting format of existing products,” “Please update the application guidelines of the recruitment information to the latest content. Please maintain the layout and expression tone of the past recruitment page and arrange the link button to the entry form at a conspicuous position,” and “Please change the representative name in the company overview to a new person in charge. Please also update the company information in the footer at the same time.” Specifically, the generative AI processing unit executes a plurality of transformer models in parallel on a GPU cluster of the server. The generative AI processing unit dynamically constructs an input prompt using a prompt generator. Input data to the model is an addition tensor of a token ID array of the constructed prompt and a positional encoding vector. The input data is, for example, a two-dimensional tensor having a context window with a maximum length of 8192 dimensions. The input data undergoes an attention mask generation process as a preprocessing. As a specific example of the input data, an instruction token “Please change the greeting text on the top page to spring content” is included. As a specific example of the input data, a feature vector indicating the tone of the past greeting texts is included. As a specific example of the input data, a text vector instructing the image of cherry blossoms is included. Output data from the model is a probability distribution matrix of a vocabulary at each step of the generated text. The output data is a two-dimensional floating-point number tensor of sequence length×vocabulary size. As a specific example of the output data, a probability score of a token “of cherry blossoms” is output. As a specific example of the output data, a probability score of a token “the season” is output. As a specific example of the output data, a probability score of a token “welcoming” is output. The generative AI processing unit applies a beam search algorithm to this output result to search for a token sequence having the highest cumulative probability. The generative AI processing unit controls diversity of the generated text by adjusting a temperature parameter. The generative AI processing unit executes a reinforcement learning model as the layout optimization AI. The model learns using arrangement coordinates of HTML elements as an action space and a degree of conformity to a design guideline as a reward function. By combining these advanced mathematical models, the system generates an update draft more accurately and faster than a human coding manually. The system improves capabilities of text generation and optimization calculation of a computer. The system can be applied to an automatic article generation and layout system of a news site. The system can be applied to personalized product recommendation page generation of an electronic commerce site.

The draft presentation unit is a unit implemented on the terminal side and configured to present the plurality of homepage update drafts generated by the generative AI processing unit to the user as preview images or HTML files. For example, it displays three drafts of greeting texts and preview images of the top page corresponding to each side by side so that the user can intuitively compare and select them. In the case of adding product information, it displays a plurality of previews of the product list page after addition, and differences in layout and design can be confirmed. In the case of updating recruitment information, it presents a plurality of drafts such as a display method for each job category and an arrangement pattern of an application button. The user can select a draft that best matches the desired content, or input a finer modification instruction in a natural language. For example, additional requests can be input, such as “I want the greeting text of this draft to be a slightly more casual expression,” “I want an illustration of cherry blossoms added to the banner image,” “I want the feature column of the product information to be in bold,” and “I want the color of the application button to match the brand color.” These additional instructions are also transmitted to the generative AI processing unit on the server side again, and a modified version of the draft is regenerated. Furthermore, even when the user additionally uploads a file such as an image or a PDF, the AI automatically performs an optimal layout and link setting, and reflects them in the draft. Specifically, the draft presentation unit executes a client-side script operating in cooperation with a browser engine of the terminal. The draft presentation unit receives update draft data transmitted in a JSON format from the server. The draft presentation unit constructs a virtual document object model on a memory based on the received data. The draft presentation unit calculates a difference between this virtual model and a model of a current screen. The draft presentation unit executes a patch process of applying only the difference to an actual screen. The draft presentation unit executes a tracking module that collects an operation log of the user. Input data to the module is a stream of event data such as mouse click coordinates, a scroll amount, and a stay time. The input data is a numerical array with a time stamp. The input data undergoes noise removal and normalization processes as a preprocessing. As a specific example of the input data, click coordinates on the preview image are included. As a specific example of the input data, millisecond data indicating a stay time in a specific text area is included. As a specific example of the input data, a percentage value indicating a scroll depth is included. Output data from the module is a feature vector estimating a user's degree of interest and modification intention. The output data is a multidimensional floating-point number array. As a specific example of the output data, a favorability score for a specific design draft is output. As a specific example of the output data, bounding box coordinates of an area desired to be modified are output. As a specific example of the output data, a category classification code of an additional request is output. The system transmits this output result to the server and uses it as a prompt tuning parameter at the time of next draft generation. The system reduces a rendering load of the screen by differential update using the virtual model. The system realizes interactive operability while suppressing consumption of a network bandwidth. The system can be applied to a preview system of a 3D CAD model for architectural design. The system can be applied to an automatic editing preview tool for video production.

The approval and reflection unit is a unit implemented on the server side and configured to automatically reflect the update draft finally approved by the user in the existing homepage file. Specifically, the generative AI analyzes the existing HTML, CSS, and JavaScript files to safely and accurately rewrite only a specified portion. For example, it automatically executes a partial update, such as replacing only a text portion of the greeting text with new content, adding a new product item to a product information list, updating a table of recruitment information to the latest content, replacing a banner image with a new one, newly adding a link to a PDF file, adding a link to a new page to a navigation menu, and updating company information in a footer to the latest one. Furthermore, the AI automatically checks consistency of links and navigation across a plurality of pages, and also modifies related pages as necessary. For example, when a new product is added to a product information page, a link and an introductory text can be automatically added to a top page, a news page, and a related product page. Specifically, the approval and reflection unit executes a deployment pipeline in cooperation with a version control system operating on the server. Upon receiving an approval signal from the user, the approval and reflection unit acquires an exclusive lock of a target file. The approval and reflection unit parses an HTML file to be updated to generate an abstract syntax tree. The approval and reflection unit replaces a subtree of the abstract syntax tree based on path information of an update node specified by the generative AI. The approval and reflection unit executes a link consistency check model in this replacement process. Input data to the model is directed graph data representing a hyperlink structure of the entire site. The input data is an adjacency list having a URL of each page as a node and a link as an edge. The input data undergoes a depth-first search process of reachability as a preprocessing. As a specific example of the input data, edge information from the top page to the product page is included. As a specific example of the input data, edge information from the product page to the PDF file is included. As a specific example of the input data, hierarchical structure data of the navigation menu is included. Output data from the model is an array of error flags indicating existence of a broken link or an isolated node and a list of modification proposal paths. As a specific example of the output data, a Boolean value indicating a broken link is output. As a specific example of the output data, an HTML element ID of an anchor tag to be modified is output. As a specific example of the output data, an alternative correct URL character string is output. The approval and reflection unit automatically modifies the abstract syntax tree based on this output result. The approval and reflection unit writes the modified abstract syntax tree to a file and executes a commit process. The approval and reflection unit transmits a cache purge request to an edge cache server. The system completely eliminates a human error accompanying a manual update by these processes. The system mathematically guarantees data consistency of the entire site. The system can be applied to an automatic update system of a large-scale online manual. The system can be applied to a synchronization process of a distributed file system across a plurality of servers.

The backup management unit is implemented on the server side, and is a unit that automatically saves a set of current homepage files as a backup before executing an update operation. For example, it saves all related files constituting the homepage, such as HTML files, CSS files, JavaScript files, image files, PDF materials, video files, and setting files for external service linkage, with time information, and performs past version management. Thereby, even if a defect occurs after the update, it can be restored to an original state with one click in an emergency. Furthermore, it records all update histories, and enables confirmation of who made what kind of change and when from a management screen. For example, it can display detailed histories in chronological order, such as “Apr. 1, 2024 10:00 Top page greeting text update,” “Apr. 2, 2024 15:30 Product information addition,” and “Apr. 3, 2024 9:00 Recruitment information modification.” Specifically, the backup management unit executes a snapshot acquisition process at a file system level of the server. The backup management unit copies metadata of the file system before starting an update transaction. The backup management unit writes only changed data blocks to a physical storage using a copy-on-write method. The backup management unit executes a cryptographic hash function to verify the integrity of backup data. Input data to the hash function is a binary stream in which a group of files to be backed up is concatenated. The input data is a byte array of an arbitrary length. The input data undergoes a padding process to a fixed-length block as preprocessing. As a specific example of the input data, binary data of an HTML file is included. As a specific example of the input data, binary data of an image file is included. As a specific example of the input data, binary data of a setting file is included. Output data from the hash function is a fixed-length hash value. The output data is, for example, a 256-bit hexadecimal character string. As a specific example of the output data, a hash value by a SHA-256 algorithm is output. As a specific example of the output data, an array of checksum values for each file is output. As a specific example of the output data, a Merkle tree root hash of the entire directory tree is output. The backup management unit records this output result in a blockchain-based tamper-proof log. The backup management unit verifies data identity by comparing a hash value of a current file with a hash value of the log at the time of restoration. The system minimizes an IO load of a backup process by the copy-on-write method. The system reliably detects data falsification or corruption by hash verification. The system improves a storage management technology of a computer and improves robustness of the system. The system can be applied to data preservation of an electronic medical record system of a medical institution. The system can be applied to an archive system of transaction records of a financial institution.

In this way, the system according to the present embodiment has the user input unit, the internal information acquisition unit, the generative AI processing unit, the draft presentation unit, the approval and reflection unit, and the backup management unit, each of which corresponds to specific and diverse cases, and is configured to eliminate personalization of the homepage with generative AI as a core, and enable anyone to easily realize high-quality homepage update. Specific examples of prompt sentences to be read by the generative AI include “Please change the greeting text on the top page to spring content. Please maintain the tone of past greeting texts and incorporate an image of cherry blossoms,” “Please add information on new product B to the product list page. Please include a product name, a model number, specifications, a price, a release date, features, an image, and a link to a catalog PDF in accordance with a posting format of existing products,” “Please update the application guidelines in the recruitment information to the latest content. Please maintain the layout and expression tone of past recruitment pages and place a link button to an entry form in a conspicuous position,” and “Please change the representative name in the company overview to a new person in charge. Please also update the company information in the footer at the same time,” and by these prompt sentences, the generative AI can maximize the use of internal assets and automatically generate an optimal homepage update draft. Specifically, the system is an autonomous information processing system in which each unit cooperates via an event-driven architecture. The system realizes asynchronous communication between respective components using a message broker. The system executes a reinforcement learning agent for automatic optimization of prompt engineering. Input data to the agent is a token array of past prompt character strings and log data of user approval and modification histories. The input data is a multidimensional tensor expressing a state space. The input data undergoes a calculation process of a reward function as preprocessing. As a specific example of the input data, a vector representation of a prompt “Please change the greeting text on the top page to spring content” is included. As a specific example of the input data, a positive reward value indicating that the user approved at once is included. As a specific example of the input data, a negative penalty value indicating that the user gave modification instructions a plurality of times is included. Output data from the agent is a vector of optimization parameters to be applied at the time of next prompt generation. The output data is an update value of a policy gradient in an action space. As a specific example of the output data, a coefficient for increasing a weight of a specific keyword is output. As a specific example of the output data, a scalar value for adjusting a length of the prompt is output. As a specific example of the output data, an index value specifying a range to be included in a context is output. The system dynamically fine-tunes an input prompt of the generative AI using this output result. The system self-learns by continuing operation, and continuously improves the quality of the generated draft. The system is not a mere collection of tools, but an adaptive computer system provided with a feedback loop. Thereby, the system maximizes output accuracy while reducing operation costs. The system can be applied to an automatic response script generation system for customer support. The system can be applied to an automatic generation system for personalized direct mail.

### Implementation Steps

Step 1: User Request Input. A person in charge of updating a homepage inputs which part of the homepage is to be changed and how in a natural language using a user interface on a terminal. For example, the person in charge inputs requests by various means such as text input, voice input, image attachment, and file upload, such as “I want to change the greeting text on the top page to spring content,” “I want to add information on new product B,” “I want to replace the application guidelines in the recruitment information with the latest ones,” “I want to change the representative name in the company overview to a new person in charge,” “I want to replace the image of the access map with a new map,” and “I want to use this image for the banner on the top page.” The input content is transmitted to a server in real time. Specifically, in this step, the terminal processes a signal from an input device via an interrupt handler of an operating system. The terminal converts a scan code from a keyboard into a character encoding. In the case of voice input, the terminal samples analog voice as PCM data via an audio interface. The terminal inputs the sampled voice data to an acoustic feature extraction model. Input data to this model is a one-dimensional array of amplitude values of a voice waveform. The input data is, for example, time-series data of floating-point numbers sampled at 16 kHz. The input data undergoes a conversion process into Mel-frequency cepstral coefficients as preprocessing. As a specific example of the input data, an acoustic feature vector of an utterance “of the top page” is included. As a specific example of the input data, an acoustic feature vector of an utterance “the greeting text” is included. As a specific example of the input data, an acoustic feature vector of an utterance “I want to change” is included. Output data from this model is a time-series sequence of a probability distribution of phonemes. The output data is a probability score matrix of phoneme classes at each time step. As a specific example of the output data, a probability score of a phoneme “t” is output. As a specific example of the output data, a probability score of a phoneme “o” is output. As a specific example of the output data, a probability score of a phoneme “p” is output. The terminal decodes this output result into a text character string in combination with a language model. The terminal serializes the generated text data and the attached image binary data into a JSON payload. The terminal establishes a persistent bidirectional communication channel with the server using a WebSocket protocol. The terminal streams the payload in real time via this channel. The system thereby eliminates the overhead of HTTP requests and minimizes communication delay. The system realizes an improvement in computer network technology, which is the efficiency of data transfer. The system can be applied to a real-time medical interview system in telemedicine. The system can be applied to a voice control interface for factory equipment.

Step 2: Automatic Collection of Internal Information. An internal information acquisition unit on the server side automatically searches for and acquires all internal assets related to homepage operation, such as internal file servers and databases, past homepage-related programs, update histories, design templates, guidelines, operation manuals, HTML files, CSS files, JavaScript files, image materials, logo data, meeting minutes, emails, design data delivered from external contractors, and API specifications of external services. For example, it comprehensively collects transitions of past greeting texts on the top page, posting formats of product information, description rules of recruitment information, brand colors and font specifications, layout templates, various banner images, operation guidelines for each department, compliance checklists created by a legal department, expression tone manuals created by a public relations department, and the like, and provides them to a generative AI processing unit. Specifically, the internal information acquisition unit includes a crawler module and a database connection module. The internal information acquisition unit executes asynchronous communication to a plurality of storage nodes on an internal network. The internal information acquisition unit converts the acquired unstructured data into text vectors by a natural language processing module. The internal information acquisition unit converts image data into image feature tensors using a convolutional neural network. The internal information acquisition unit stores these vectors and tensors in a vector database as indexes on a high-dimensional vector space. The internal information acquisition unit calculates a cosine similarity with the text vector of the user input. The internal information acquisition unit extracts internal asset data whose similarity exceeds a predetermined threshold. Thereby, the system extracts related information from a huge amount of internal data at high speed and with high accuracy. The system significantly reduces computational resources and communication bandwidth required for the search. The system transfers the extracted data to the generative AI processing unit as an input tensor. As a use case, it is applied to instantaneous extraction of past campaign histories in a large-scale EC site operating company, and the like.

Step 3: Generation of Update Drafts by Generative AI. A generative AI processing unit receives desired content in a natural language transmitted from a user input unit and various internal assets acquired by an internal information acquisition unit as input information, and automatically generates a plurality of homepage update drafts by combining a large language model, image generation AI, code generation AI, layout optimization AI, expression tone determination AI, and the like. For example, in response to a request to change the greeting text on the top page to spring content, it automatically generates a plurality of candidate texts such as “Greetings for the New Fiscal Year,” “Welcoming the Cherry Blossom Season,” and “Information on New Spring Products” while referring to expressions of past greeting texts and internal tones and manners, and also generates a plurality of image drafts such as “a background image with fluttering cherry blossom petals,” “a banner imaging fresh greenery,” and “an image with a catchphrase supporting a new life in spring” using the image generation AI. In the case of adding product information, it refers to posting formats and expression rules of past product information, and automatically generates specified new product information (product name, model number, specifications, price, release date, features, image, catalog PDF, etc.) with an appropriate layout and design. Specific examples of prompt sentences to be read by the generative AI include “Please change the greeting text on the top page to spring content. Please maintain the tone of past greeting texts and incorporate the image of cherry blossoms,” “Please add information on new product B to the product list page. Please include the product name, model number, specifications, price, release date, features, image, and link to the catalog PDF in accordance with the posting format of existing products,” “Please update the application guidelines in the recruitment information to the latest content. Please maintain the layout and expression tone of past recruitment pages and place a link button to an entry form in a conspicuous position,” and “Please change the representative name in the company overview to a new person in charge. Please also update the company information in the footer at the same time.” Specifically, the generative AI processing unit includes a large language model based on a Transformer architecture and image generation AI based on a diffusion model. The generative AI processing unit combines the user input text and the extracted internal asset data. The generative AI processing unit converts the combined data into a token sequence by a tokenizer. The generative AI processing unit converts the token sequence into a multidimensional input embedding tensor. The generative AI processing unit calculates a dependency relationship between each element in the input embedding tensor using a self-attention mechanism. The generative AI processing unit generates a hidden state vector reflecting the context. The generative AI processing unit calculates an output token probability distribution through a decoder layer. The generative AI processing unit generates a plurality of text sequences with the highest probability using a beam search algorithm. Output data is structured text data including HTML tags, and a certainty score of each generated draft. The image generation AI receives a text prompt as a conditioning vector. The image generation AI executes a reverse diffusion process of removing noise stepwise from a random noise tensor. The image generation AI outputs an RGB image tensor of, for example, 512×512 pixels. The generative AI processing unit integrates the generated text and image to construct a plurality of update draft datasets. The system transmits the update draft datasets to a subsequent draft presentation unit. The system eliminates conventional manual coding work by using a probabilistic generation method in a high-dimensional space. The system dramatically improves the processing speed of web page generation. As a use case, it is applied to automation of full renewal of the top page for each season, and the like.

Step 4: Presentation of Drafts and User Selection/Additional Instruction. A draft presentation unit presents the plurality of homepage update drafts generated by the generative AI processing unit to the user as preview images or HTML files. For example, it displays three drafts of greeting texts and preview images of the top page corresponding to each side by side so that the user can intuitively compare and select them. In the case of adding product information, it displays a plurality of previews of the product list page after addition so that differences in layout and design can be confirmed. In the case of updating recruitment information, it presents a plurality of drafts such as a display method for each job type and an arrangement pattern of application buttons. The user can select a draft that best matches the desired content, or input a finer modification instruction in a natural language. For example, the user can input additional requests such as “I want the greeting text of this draft to be a slightly more casual expression,” “I want an illustration of cherry blossoms to be added to the banner image,” “I want the feature column of the product information to be bold,” and “I want the color of the application button to match the brand color.” These additional instructions are also transmitted to the generative AI processing unit again, and a modified version of the draft is regenerated. Specifically, the draft presentation unit inputs the received update draft datasets to a rendering engine. The draft presentation unit constructs a virtual DOM tree on a memory. The draft presentation unit executes a pixel mapping process from the DOM tree to generate a preview image tensor. The draft presentation unit outputs a plurality of preview image tensors in parallel to a display device of the terminal. The terminal receives a selection operation or an additional natural language input from the user. The terminal converts the additional input into a text vector. The terminal transmits the text vector to the server together with an identifier of the selected draft. The generative AI processing unit combines the received text vector with an existing hidden state vector as a new conditioning tensor. The generative AI processing unit executes a re-inference process using the combined tensor. The generative AI processing unit re-outputs the modified HTML code and image tensor. The system utilizes an attention cache mechanism that recalculates only difference data. The system reduces a calculation load required for regeneration and improves a response speed. The system realizes iterative optimization that accurately reflects the user's intention. As a use case, it is applied to landing page production work that repeats fine adjustments of design, and the like.

Step 5: Reflection of Approved Draft and Automatic Update. An approval and reflection unit automatically reflects the update draft finally approved by the user in an existing homepage file. The generative AI analyzes existing HTML, CSS, and JavaScript files to safely and accurately rewrite only a specified portion. For example, it automatically executes a partial update, such as replacing only a text portion of a greeting text with new content, adding a new product item to a product information list, updating a table of recruitment information to the latest content, replacing a banner image with a new one, newly adding a link to a PDF file, adding a link to a new page to a navigation menu, and updating company information in a footer to the latest one. The AI also automatically checks the consistency of links and navigation across a plurality of pages, and modifies related pages as necessary. Specifically, the approval and reflection unit receives the finally approved update draft dataset. The approval and reflection unit inputs a group of source codes constituting an existing website to a syntax analysis module. The syntax analysis module converts the source code into an abstract syntax tree data structure. The approval and reflection unit collates a change instruction vector included in the update draft dataset with the abstract syntax tree. The approval and reflection unit identifies a specific node to be changed. The approval and reflection unit overwrites an attribute value or text data of the identified node with new data. The approval and reflection unit reserializes the updated abstract syntax tree to generate a new source code file. The approval and reflection unit activates a link consistency verification module. The link consistency verification module develops a hyperlink structure of the entire site as a directed graph on a memory. The link consistency verification module detects an isolated node or an invalid edge using a graph search algorithm. When detecting an error, the link consistency verification module automatically modifies path information of a related file. The system executes structural rewriting at a syntax level, not simple character string replacement by a regular expression. The system completely prevents code corruption and occurrence of syntax errors. The system dramatically improves the operational stability of the website. As a use case, it is applied to simultaneous information update of a large-scale corporate site extending to thousands of pages, and the like.

Step 6: Backup and History Management. A backup management unit automatically saves a set of current homepage files as a backup before executing update work. It saves all related files constituting the homepage, such as HTML files, CSS files, JavaScript files, image files, PDF materials, video files, and setting files for external service cooperation, with time information, and performs past version management. Even if a defect occurs after the update, it can be restored to an original state with one click. It records all update histories so that who made what changes and when can be confirmed from a management screen. Specifically, the backup management unit detects a start trigger of an update process. The backup management unit calculates a hash value of a target file group using a cryptographic hash function. The backup management unit compares the calculated hash value with a previous hash value. The backup management unit extracts only a file in which a difference is detected. The backup management unit converts the extracted file into a binary data block by a compression algorithm. The backup management unit adds a time stamp and a user identifier to the binary data block. The backup management unit writes these to a version management database on a non-volatile storage device. When receiving a restoration request, the backup management unit reads a binary data block corresponding to a specified time stamp. The backup management unit decompresses the binary data block and reconstructs the original file group on a memory. The backup management unit overwrites a storage of a production environment with the reconstructed file group. The system combines a differential backup method and a hash-based consistency check. The system guarantees data integrity while minimizing consumption of storage capacity. The system brings a technical effect of minimizing downtime when a failure occurs. As a use case, it is applied to safe operation management of a news site or an EC site where content is frequently updated.

### Specific Use Case

For example, a use case is assumed in which a greeting text posted on a top page of a homepage is updated to spring content in accordance with a change of seasons. In this case, a person in charge of updating the homepage inputs “I want to change the greeting text on the top page to spring content” in a natural language using a user interface of a terminal. The input content is transmitted to a server, and an internal information acquisition unit automatically collects past greeting texts, internal tone and manner guidelines, brand colors and font specifications, expression examples of past greeting texts for each season, related image materials, banner images, HTML files, CSS files, and the like. A generative AI processing unit automatically generates a plurality of greeting text drafts based on these pieces of information and the user's request. For example, it generates expressions incorporating a sense of the season while maintaining an internal tone, such as “Greetings for the New Fiscal Year,” “Welcoming the Cherry Blossom Season,” and “Information on New Spring Products,” and further generates banner drafts such as “a background image with fluttering cherry blossom petals,” “a banner imaging fresh greenery,” and “an image with a catchphrase supporting a new life in spring” by image generation AI. Specific examples of prompt sentences to be read by the generative AI include “Please change the greeting text on the top page to spring content. Please maintain the tone of past greeting texts and incorporate the image of cherry blossoms,” and “Please generate a banner image imaging spring. Please use the brand color as a base tone and decorate it with cherry blossom petals.” Specifically, the system receives a text character string in a natural language via the input interface of the terminal. The system inputs the text character string to a natural language processing engine. The natural language processing engine performs morphological analysis on the text character string, and generates an update request vector using an intent classification model. The internal information acquisition unit searches a vector database using the update request vector as a query. The internal information acquisition unit extracts a related document group including past greeting text data and brand guidelines. The generative AI processing unit combines the extracted document group and the update request vector to construct a prompt tensor. The generative AI processing unit supplies the prompt tensor to an input layer of a large language model. The large language model is a Transformer network having billions of parameters. The large language model executes an autoregressive inference process, and outputs text sequences of a plurality of greeting text candidates. At the same time, the generative AI processing unit generates a conditioning vector for image generation. The generative AI processing unit inputs the conditioning vector to a latent diffusion model. The latent diffusion model iteratively executes a noise removal step in a latent space. The latent diffusion model outputs a high-resolution banner image tensor via a decoder network. The system synchronously executes text generation and image generation on a parallel processing architecture. The system significantly shortens a calculation time required for multimodal content generation. As a use case, it is applied to automatic generation work of a campaign page for each season, and the like.

A draft presentation unit presents the generated plurality of greeting text drafts and banner image drafts to the user in a preview format, and the user inputs additional requests in a natural language, such as “I want the greeting text of this draft to be a slightly more casual expression” and “I want an illustration of cherry blossoms to be added to the banner image.” These additional instructions are also retransmitted as prompts to the generative AI, and prompt sentences such as “Please modify the greeting text to a more casual tone” and “Please add an illustration of cherry blossoms to the banner image” are used. The generative AI generates modified versions of the greeting text drafts and banner image drafts again, and presents them to the user. Specifically, the draft presentation unit integrates the generated text sequence and image tensor. The draft presentation unit inputs the integrated data to an HTML rendering engine to generate a temporary DOM structure for preview. The draft presentation unit visualizes the temporary DOM structure on a display of the terminal. The terminal receives an additional natural language instruction from the user. The terminal converts the additional instruction into a text vector, and transmits it to the server. The generative AI processing unit interprets the received text vector as a difference prompt. The generative AI processing unit reads cache tensors of attention keys and values held on a memory during the previous inference. The generative AI processing unit inputs only a new token vector corresponding to the difference prompt to the network. The generative AI processing unit omits calculation of a self-attention mechanism by utilizing the cache tensor. The generative AI processing unit outputs the modified text sequence and image tensor at high speed. The system dramatically reduces consumption of calculation resources by this cache-utilizing re-inference method. The system minimizes a response delay of the system to user feedback. As a use case, it is applied to a live editing session of web design that responds to client requests in real time, and the like.

The approval and reflection unit automatically reflects the greeting text draft and the banner image draft finally approved by the user in the existing homepage file. The generative AI replaces only the greeting text portion of the existing HTML file with new content, and replaces the banner image portion with a new image. Furthermore, it automatically checks the adjustment of related CSS files and the consistency of links and navigation across a plurality of pages, and modifies related pages as necessary. The backup management unit saves a set of homepage files with time information before executing the update work, and performs past version management. As a result, even if a defect occurs after the update, it can be restored to the original state with a single click in an emergency. Specifically, the approval and reflection unit holds the approved text sequence and image tensor in a memory as confirmed data. The approval and reflection unit reads the target existing HTML file, and converts it into a hierarchical node object group using a DOM tree parser. The approval and reflection unit searches for a specific text node and image node to be updated using an algorithm of XPath or a CSS selector. The approval and reflection unit replaces a property value of the specified node with the confirmed data. The approval and reflection unit serializes the updated node object group, and writes it out to a storage as a new HTML file. The approval and reflection unit activates a CSS analysis module, and automatically recalculates a layout parameter based on dimension data of the replaced image. The approval and reflection unit updates the CSS file with the recalculated parameter. The backup management unit binary-compresses the original file group immediately before writing out the file, adds a time stamp, and stores it in an archive database. The system executes precise node operation at a DOM tree level. The system completely eliminates unexpected code destruction caused by regular expression replacement. The system realizes safe automatic update while maintaining structural consistency of a website. As a use case, it is applied to a safe partial update task of a portal site having a complex layout, and the like.

Also, for example, in a use case of adding new product information to the homepage, a person in charge inputs “I want to add information on new product C to the product list page,” and uploads information such as a product name, a model number, specifications, a price, a release date, features, an image, and a catalog PDF. As an example of a prompt sentence to be read by the generative AI, “Please add the information on new product C to the product list page. Please include the product name, the model number, the specifications, the price, the release date, the features, the image, and a link to the catalog PDF in accordance with a posting format of existing products” is given. The generative AI refers to the posting format and expression rules of past product information, automatically generates the specified new product information with an appropriate layout and design, and presents a plurality of drafts. The user compares differences in layout and design, inputs an additional request such as “I want the feature column to be in bold” or “I want the product image to be displayed a little larger” as necessary, and the AI generates a modified version of the draft again. When the final draft is approved, HTML, CSS, and image files are automatically updated, and links and introduction texts are automatically added to related top pages, news pages, and related product pages. Specifically, the system receives attribute data and image data of the new product input from the terminal. The system converts the attribute data into a structured JSON object. The generative AI processing unit includes a code generation neural network pre-trained using an HTML structure of past product pages as learning data. The generative AI processing unit supplies the structured JSON object as an input tensor to the code generation neural network. The code generation neural network encodes the input tensor into a latent space vector. The code generation neural network generates a code snippet including an HTML tag and a CSS class conforming to an existing site design through a decoder layer. The generative AI processing unit outputs a plurality of patterns of the generated code snippets. The system analyzes a layout change instruction from the user by a natural language processing module. The system dynamically rewrites a specific CSS property in the code snippet based on an analysis result. The approval and reflection unit inserts the finally approved code snippet directly under an appropriate parent node in a DOM tree of the product list page. The system automatically additionally registers metadata of the new product in an index database of an in-site search engine. The system eliminates a manual coding mistake by using a code generation method based on structured data. The system significantly reduces a work time required for adding a product. As a use case, it is applied to operation of an online catalog in which hundreds of products are frequently replaced, and the like.

Furthermore, for example, in a use case of updating application guidelines of recruitment information to the latest ones, “I want to update the application guidelines of the recruitment information to the latest content” is input, and information such as a job type, a work location, a salary, application qualifications, a selection flow, and an entry form URL is input or uploaded. As an example of a prompt sentence to be read by the generative AI, “Please update the application guidelines of the recruitment information to the latest content. Please maintain a layout and an expression tone of past recruitment pages, and arrange a link button to the entry form at a conspicuous position” is given. The generative AI automatically generates HTML and CSS codes reflecting the latest information while following a configuration and an expression of the past recruitment pages, and presents a plurality of drafts. The user inputs an additional request regarding a color and an arrangement of an application button, a display method for each job type, and the like, and the AI regenerates a modified version. After approval, the existing recruitment information page is automatically updated, and related navigation and footer information are also modified as necessary. Specifically, the system receives recruitment-related text data and a URL character string input from the terminal. The system maps these data to a key-value type data structure. The generative AI processing unit executes a pattern recognition algorithm that analyzes a DOM structure of the past recruitment pages and extracts layout regularity. The generative AI processing unit combines the extracted regularity parameter and the key-value type data structure. The generative AI processing unit inputs the combined data to a Transformer-based code generation model. The code generation model evaluates a relationship between respective data items using a self-attention mechanism. The code generation model outputs HTML and CSS code blocks corresponding to a responsive design. The system calculates arrangement coordinates of a link element in the output code block. The system optimizes a CSS arrangement property of a button element to a position where a user's attention degree is highest using a line-of-sight prediction AI model. The system recalculates a color code and a margin value of the button in accordance with the additional request from the user, and updates the code block. The approval and reflection unit replaces a corresponding section of the existing recruitment information page with the new code block. The system automatically executes layout optimization based on line-of-sight prediction. The system brings about a technical effect of improving a conversion rate from the recruitment page. As a use case, it is applied to operation of a recruitment portal site of a large company that frequently updates application guidelines for a plurality of job types, and the like.

In this way, the system of the present invention can automatically and safely realize a final homepage update while a user inputs a request in a natural language, the generative AI automatically generates a plurality of update drafts by maximizing the use of internal assets, and flexibly responding to an additional instruction from the user. As specific examples of the prompt sentence to be read by the generative AI, “Please change the greeting text on the top page to spring content. Please maintain the tone of past greeting texts and incorporate an image of cherry blossoms,” “Please add the information on new product C to the product list page. Please include the product name, the model number, the specifications, the price, the release date, the features, the image, and a link to the catalog PDF in accordance with a posting format of existing products,” “Please update the application guidelines of the recruitment information to the latest content. Please maintain a layout and an expression tone of past recruitment pages, and arrange a link button to the entry form at a conspicuous position,” and the like are given. Specifically, the system includes a pipeline architecture integrating a natural language processing module, a vector database, a large language model, and a DOM manipulation engine. The system converts a natural language input, which is unstructured data, into an embedding tensor on a high-dimensional vector space. The system extracts related context data from an internal asset database at high speed using the embedding tensor. The system combines the extracted context data and the user input, and dynamically constructs an optimized prompt tensor. The system inputs the prompt tensor in parallel to the large language model and an image generation model. The system generates a syntactically accurate HTML code, CSS code, and optimized image tensor by inference processing. The system renders the generated assets on a virtual DOM, and executes differential update based on user feedback at high speed using an attention cache mechanism. The system safely deploys a final code to a production environment by node replacement processing at an abstract syntax tree level. The system combines these non-conventional computer processing methods. The system replaces website update work that has relied on human mental processes with a fully automated deterministic and probabilistic calculation process. The system dramatically improves processing speed, accuracy, and system stability of the update work. As a use case, it is applied to an autonomous update system for any corporate website operated by a person in charge who does not have specialized programming knowledge.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment for carrying out the present invention, a mail-order site automatic update agent is composed of a server and a terminal, the terminal is an information processing apparatus such as a personal computer, a tablet terminal, or a smartphone, and the server is a high-performance computer installed in a cloud environment or an on-premises environment, and includes various processing functions including generative AI. A user input unit is implemented on the terminal side, and provides an interface for a person in charge of operating a mail-order site to input which part of the site is to be changed and how in a natural language. For example, a request can be input by various means such as text input, voice input, image attachment, and file upload, such as “I want to add new product F. The product name is ‘portable air purifier’, the price is 12,800 yen, the features are ‘USB charging, portable, quiet’, and the image file is portable.jpg,” “I want to post this weekend's time sale ‘20% off all home appliances’ conspicuously on the top page,” “I want to add a question ‘Is overseas shipping possible?’ and an answer ‘Yes. International shipping fee will be charged separately’ to the FAQ,” “I want to make the expression of the delivery guide page easy for the elderly to understand,” “I want to change the review display to a combined type of star rating and comment,” “I want to display related product recommendations in a carousel type,” and “I want to add a guidance text for a payment method in English for foreigners.” Input content is transmitted to the server in real time, and automatic completion of the input content, presentation of an input example, typographical error check, automatic display of a guideline according to the input content, and the like can also be performed. Specifically, the mail-order site automatic update agent is constructed on a distributed processing cluster composed of a plurality of calculation nodes. The server is equipped with a plurality of hardware accelerators specialized for tensor calculation. The user input unit includes an asynchronous communication module operating on a browser of the terminal. The user input unit acquires a text character string, voice waveform data, or image pixel data input by the user in real time. The user input unit inputs the voice waveform data to a voice recognition engine using a hidden Markov model or a recurrent neural network, and converts it into text data. The user input unit sequentially transmits the input text data to the server in units of characters or words. A natural language processing module on the server side analyzes the received text stream using an N-gram model or a Transformer encoder. The server calculates a probability distribution of a word highly likely to be input next. The server returns a word string with the highest probability to the terminal as a predicted text vector. The user input unit decodes the predicted text vector, and displays it as an automatic completion candidate on an input field. The server detects a spelling mistake or a grammatical error in the input text using a rule-based engine and a statistical language model, and generates a correction candidate vector. The system executes these real-time input support processes by background asynchronous communication. The system significantly reduces a user's input load, and improves quality of input data passed to subsequent AI processing. As a use case, it is applied to a mobile operation environment in which a busy EC site operator quickly issues a site update instruction from a smartphone, and the like.

A site information acquisition unit is implemented on the server side, and automatically searches for and acquires all internal assets related to mail-order site operation, such as past HTML files, CSS files, and JavaScript files of the mail-order site, a product database, a campaign history, FAQ data, delivery guide data, a design guideline, a brand color, a font specification, an image material, a banner template, an expression tone manual, a past banner image, a news article, design data delivered from an outsourcee, an API specification of an external service, an SEO countermeasure manual, an accessibility guideline, a review display template, a related product logic, a payment guidance text template, and multilingual support data. For example, the AI comprehensively collects a layout and an expression when a new product was added in the past, a posting pattern of sale information, a Q&A format and an explanation example with an illustration of FAQ, a transition of an expression of a delivery guide page, a brand color and a font specification, a design template of a banner image, an expression tone manual, a setting file for external service linkage, a past example of a title and a description for SEO optimization, an example of adding an alt attribute and an aria label for accessibility support, each pattern with a star rating, a comment, and an image of a review display, each draft of a side-by-side type, a carousel type, and a pop-up type of a related product recommendation, a multilingual support example such as Japanese, English, and Chinese of a payment guidance text, a limited banner during a campaign period, an automatic switching scheduling example, and the like. Furthermore, for example, a past arrangement order and a category configuration of a product list page, a posting method of a review and a word of mouth, a recommendation logic of a related product, a linkage specification with an external payment service, an API specification of an external delivery service, a past version of a return policy and terms of use, an expression example of a gift wrapping guide, a posting example of sustainability information, a past case of video embedding, an arrangement example of an SNS linkage banner, and the like can also be set as acquisition targets. Specifically, the site information acquisition unit includes a data extraction daemon that communicates with a distributed file system and a relational database management system. The site information acquisition unit collects various files on an internal network by periodic crawl processing. The site information acquisition unit analyzes the collected HTML file and CSS file by a DOM parser, and extracts structured tag information and style attributes. The site information acquisition unit converts the extracted text data into a multidimensional embedding vector using a natural language processing model. The site information acquisition unit inputs an image material and a banner image to a convolutional neural network. The convolutional neural network extracts a visual feature amount tensor from the image. The site information acquisition unit stores the generated text embedding vector and visual feature amount tensor in a vector database as an index on a high-dimensional vector space. The site information acquisition unit similarly converts an update request text transmitted from the user input unit into a request vector. The site information acquisition unit calculates an inner product or a cosine similarity between the request vector and each index in the vector database. The site information acquisition unit instantly specifies a parameter group of past layout data, a design guideline, and a related product logic whose similarity score exceeds a predetermined threshold, and loads it onto a memory. The system realizes semantic information retrieval that does not depend on keyword matching by using vector similarity retrieval in a high-dimensional space. The system brings about a technical effect of extracting optimal context data from a huge amount of internal assets at high speed and with high accuracy. As a use case, it is applied to operation optimization of a large-scale EC mall that reuses a huge amount of past campaign histories and design assets, and the like.

The generative AI processing unit is implemented on the server side, receives desired content in a natural language transmitted from the user input unit and various internal assets acquired by the site information acquisition unit as input information, and automatically generates a plurality of mail-order site update drafts by combining generative AI, that is, a large language model, image generation AI, code generation AI, layout optimization AI, expression tone determination AI, SEO optimization AI, accessibility check AI, multilingual translation AI, and the like. For example, in the case of adding a new product, it generates drafts with different layouts and expressions, such as “Draft 1: Post a product description mainly with text, and arrange an image on the right side,” “Draft 2: Emphasize features with bullet points, and arrange a large image in the center,” “Draft 3: Emphasize USB charging, portable, and quiet like a banner, and set a link to a catalog PDF under the product image,” “Draft 4: Automatically generate an SEO-optimized title and description, and display related product recommendations in a carousel type,” and “Draft 5: Arrange a review display at the bottom in a combined type of star rating and comment.” In the case of sale information, it generates a plurality of drafts, such as “Draft 1: Post sale information in a banner area of the top page,” “Draft 2: Display sale information in a pop-up,” “Draft 3: Add sale information to a news column, and guide with a banner,” “Draft 4: Set scheduling to automatically return to an original banner after a sale period ends,” and “Draft 5: Display an SNS linkage banner at the same time.” In the case of FAQ, it generates drafts including differences in expression methods, such as “Draft 1: Add in a Q&A format,” “Draft 2: Explain with an illustration,” “Draft 3: Insert a video link,” “Draft 4: Automatically generate English and Chinese pages with multilingual support,” and “Draft 5: Automatically add text for voice reading with accessibility support.” In the case of a delivery guide, it automatically generates drafts tailored to a user layer and operation requirements, such as “Draft 1: Concisely modify sentences,” “Draft 2: Explain with an illustration,” “Draft 3: Organize in a table format,” “Draft 4: Use large characters and easy-to-understand icons for the elderly,” and “Draft 5: Automatically generate an API linkage guide of an external delivery service.” Furthermore, for example, the generative AI can also automatically create drafts for an SEO optimization draft of a product page, a variation of a review display method, a display pattern of a related product recommendation, a difference in expression of a payment guidance text, automatic generation of a limited banner during a campaign period, automatic generation of a multilingual support page, automatic check and modification draft generation for accessibility support, automatic generation of an SNS linkage banner, automatic generation of a video embedding draft, a difference in expression of a gift wrapping guide, a posting draft of sustainability information, an automatic update draft of a return policy and terms of use, and the like. Specifically, the generative AI processing unit includes an ensemble inference engine integrating a plurality of specialized neural network models. The generative AI processing unit combines a user's desired content vector and a context data tensor loaded from the site information acquisition unit. The generative AI processing unit supplies the combined tensor to an input layer of the large language model. The large language model executes an autoregressive token generation process, and outputs a plurality of code snippet drafts including an HTML tag, a CSS class, and text content. At the same time, the generative AI processing unit activates an SEO optimization AI module. The SEO optimization AI module analyzes the generated text content, and calculates a keyword frequency vector conforming to an algorithm of a search engine. The SEO optimization AI module generates an optimal title tag and meta description character string. The generative AI processing unit activates an accessibility check AI module. The accessibility check AI module scans an image tag in the generated code snippet, and texturizes content of an image using an image recognition model. The accessibility check AI module automatically adds the texturized content as an alt attribute value. The generative AI processing unit inputs the generated Japanese text to a Transformer-based translation model using a multilingual translation AI module. The translation model outputs a text vector of another language such as English or Chinese. The system executes inference processing by these plurality of AI models in parallel on a GPU cluster. The system generates a plurality of update draft datasets simultaneously satisfying multifaceted requirements such as layout, SEO, accessibility, and multilingual support at high speed. The system integrates an optimization process conventionally performed manually by a plurality of experts into a single calculation pipeline, and dramatically improves processing efficiency. As a use case, it is applied to an automatic generation task of a multilingual and multifunctional page in a cross-border EC site expanding globally, and the like.

As specific examples of the prompt sentence to be read by the generative AI, “Please add new product F ‘portable air purifier’ to the product page. The price is 12,800 yen, the features are USB charging, portable, and quiet, use the image file portable.jpg, and match the layout of existing products,” “Please post this weekend's time sale ‘20% off all home appliances’ conspicuously on the top page. Please create both banner and pop-up drafts,” “Please add a question ‘Is overseas shipping possible?’ and an answer ‘Yes. International shipping fee will be charged separately’ to the FAQ. Please create drafts in a Q&A format and with an illustration,” “Please modify the expression of the delivery guide page to be easy for the elderly to understand. Please create drafts including an illustration and a table format,” “Please change the review display to a combined type of star rating and comment. Please also create a draft with an image,” “Please display related product recommendations in a carousel type,” “Please add a guidance text for a payment method in English for foreigners,” “Please generate a plurality of optimization drafts for a title and a description to strengthen SEO of the product page,” “Please automatically update the return policy to content compliant with the latest laws and regulations,” “Please add a gift wrapping guide with an easy-to-understand illustration,” “Please add sustainability information to the bottom of the product page,” “Please create a video embedding draft,” and the like are given. Specifically, the system includes a preprocessing module that automatically converts these prompt sentences in a natural language into a structured prompt tensor for internal processing. The preprocessing module performs morphological analysis on the prompt sentence, and extracts key information using an entity extraction algorithm. The preprocessing module stores the extracted key information in a parameter map in a JSON format. The preprocessing module determines an intention of the prompt sentence by a classification model, and generates an intention label vector. The preprocessing module combines the parameter map, the intention label vector, and past layout constraint data extracted from the vector database. The preprocessing module formats the combined data as a system prompt, and loads it into an input context window of the large language model. For example, when a prompt for strengthening SEO is input, the preprocessing module automatically collects existing text data of a target product, a frequent keyword vector of a competing site, and the latest evaluation criterion parameter of a search engine, and adds them to the prompt tensor. The large language model receives the prompt tensor including this rich context information as an input. The large language model generates structured output data strictly satisfying a specified constraint condition, rather than a mere character string response. The system expands a user's short natural language input into a high-dimensional constraint condition tensor for the AI model to accurately execute inference. The system brings about a technical effect of significantly improving accuracy of a generation result and conformity to business requirements. As a use case, it is applied to an interface in which a general operation person in charge who does not have specialized prompt engineering skills utilizes an advanced AI function.

The draft presentation unit is implemented on the terminal side, and presents the plurality of mail-order site update drafts generated by the generative AI processing unit to the person in charge as preview images or HTML files. For example, it displays five new product page drafts and preview images of the product list page corresponding to each side by side so that the person in charge can intuitively compare and select them. In the case of adding sale information, it displays a banner draft, a pop-up draft, a news column draft, an SNS linkage draft, and a scheduling draft side by side, and differences in design and appeal can be confirmed. In the case of adding FAQ, a Q&A format draft, a draft with an illustration, a draft with a video link, a multilingual support draft, and an accessibility support draft can be compared. In the case of modifying a delivery guide, a sentence modified version, a draft with an illustration, a table format draft, a draft for the elderly, and an external delivery service linkage draft are displayed side by side, and ease of understanding and design can be compared. In the case of a review display, it presents a plurality of drafts such as a combined type of star rating and comment, a comment-only type, a type with an image, a type with a video, and an SNS linkage type. In the case of a related product recommendation, it presents a plurality of drafts such as a side-by-side type, a carousel type, a pop-up type, a ranking type, and an AI personalized type. The person in charge can select a draft that best matches the desired content, or input a finer modification instruction in a natural language. For example, an additional request can be input, such as “I want the feature column to stand out more,” “I want the color of the banner to be the brand color,” “I want the answer of the FAQ to be a little more detailed,” “I want the illustration of the delivery guide to be larger,” “I want the review display to be a type with an image,” “I want the related product recommendation to be an AI personalized type,” “I want the payment guidance text to be added in Chinese as well,” “I want an illustration to be added to the return policy,” “I want the gift wrapping guide to be added with a video,” and “I want the sustainability information to be displayed with a graph.” These additional instructions are also transmitted to the generative AI processing unit again, and a modified version of the draft is regenerated. Furthermore, even when the person in charge additionally uploads an image, a PDF, a video file, or the like, the AI automatically performs optimal layout and link setting, and reflects it in the draft. Specifically, the draft presentation unit receives a plurality of update draft datasets transmitted from the server. The draft presentation unit activates a browser engine or a dedicated rendering module in the terminal. The rendering module constructs each update draft dataset as an independent virtual DOM tree on a memory. The rendering module converts the virtual DOM tree into pixel data, and generates a plurality of preview image tensors. The draft presentation unit displays these preview image tensors in parallel in a grid shape or a carousel shape on a display of the terminal. The terminal receives a selection input from the user or an additional natural language instruction via a text input field. The terminal converts the additional instruction into a text vector, and transmits it to the server together with an identifier of the selected draft. The generative AI processing unit processes the received text vector as a differential prompt. The generative AI processing unit reads a cache of a hidden state vector used when generating the selected draft from the memory. The generative AI processing unit combines a new input tensor corresponding to the differential prompt with the cache, and executes re-inference processing. For example, in response to a color change instruction, the generative AI processing unit rewrites a color information parameter in a conditioning vector of the image generation AI to an RGB value of the brand color, and performs regeneration. When the user uploads an image or a PDF file, the system extracts a feature amount vector by a file analysis module, and inputs it to the layout optimization AI. The layout optimization AI dynamically recalculates arrangement coordinates and a size of an element based on the extracted feature amount vector. The system minimizes a response time of the system to user feedback by differential inference and dynamic layout calculation. The system efficiently realizes an interactive and iterative design optimization process on a computer. As a use case, it is applied to a marketing task of quickly creating and comparing a plurality of landing page designs for an A/B test, and the like.

The approval and reflection unit is implemented on the server side, and automatically reflects the update draft finally approved by the person in charge in an existing mail-order site page. The generative AI analyzes existing HTML, CSS, and JavaScript files, and safely and accurately rewrites only a specified portion. For example, a new product is automatically added to a product list page or a new arrival column of a top page, sale information is displayed as a banner or a pop-up, and an FAQ page or a delivery guide page is updated to the latest content. A review display, a related product recommendation, a payment guidance text, a return policy, a gift wrapping guide, sustainability information, video embedding, and the like are also automatically reflected based on the specified draft. Furthermore, the AI automatically checks consistency of links and navigation across a plurality of pages, and modifies related pages as necessary. For example, when a new product is added, a link and an introduction text are automatically added to a related product page, a recommended product column, and a pickup column of the top page. When sale information is added, scheduling to automatically return to an original banner after a campaign period ends is also possible. Multilingual support pages for FAQ and delivery guides are also automatically generated, and links in navigation and footers are also automatically updated. Specifically, the approval and reflection unit loads the finally approved update draft dataset onto a memory as confirmed data. The approval and reflection unit reads an existing HTML file group to be updated from a storage. The approval and reflection unit converts the file group into an abstract syntax tree data structure using an HTML parser. The approval and reflection unit searches for a specific node in the abstract syntax tree based on a change instruction vector included in the confirmed data. The approval and reflection unit replaces or adds an attribute value or a child node of the specified node with content of the confirmed data. The approval and reflection unit reserializes the updated abstract syntax tree, and generates it as a new HTML file. The approval and reflection unit accesses a graph database that manages a link structure of the entire site. The approval and reflection unit adds a URL node of the new product page to the graph database. The approval and reflection unit automatically generates a new edge from a node of the related product page or the top page to the node of the new product page. The approval and reflection unit dynamically updates an abstract syntax tree of a related page based on the generated edge information, and inserts a link tag. When receiving scheduling information of a campaign, the approval and reflection unit registers an execution trigger in a task scheduler of the server. The task scheduler executes a script that automatically switches a path of a banner image at a specified date and time. The system executes structural rewriting at an abstract syntax tree level and automatic maintenance of link consistency using the graph database. The system completely eliminates human errors such as a broken link and forgetting to close a tag caused by manual work. The system dramatically improves data integrity and system operation stability in update work of a large-scale site having a complex hierarchical structure. As a use case, it is applied to operation of a large-scale EC platform that handles tens of thousands of product data and frequently undergoes category changes and sale information updates.

The backup management unit is implemented on the server side, and automatically saves a complete set of current mail-order site pages as a backup before executing an update operation. It saves all related files constituting the mail-order site, such as HTML files, CSS files, JavaScript files, image files, PDF materials, video files, and setting files for external service linkage, with time information, and performs past version management. Thereby, even if a defect occurs after an update in an emergency, it can be restored to an original state with one click. Furthermore, it records all update histories so that who made what changes and when can be confirmed from a management screen. For example, detailed histories can be displayed in chronological order, such as “Jun. 1, 2024 10:00 New product F added”, “Jun. 2, 2024 15:30 Time sale posted”, “Jun. 3, 2024 9:00 FAQ modified”, “Jun. 4, 2024 11:00 Delivery guide updated”, “Jun. 5, 2024 13:00 Review display changed”, “Jun. 6, 2024 14:00 Related product recommendation changed”, “Jun. 7, 2024 16:00 Payment guide text added”, “Jun. 8, 2024 17:00 Return policy updated”, “Jun. 9, 2024 18:00 Gift wrapping guide added”, “Jun. 10, 2024 19:00 Sustainability information added”, and “Jun. 11, 2024 20:00 Video embedding added”. Specifically, the backup management unit intercepts an update execution signal from the approval and reflection unit. The backup management unit applies a cryptographic hash function to all files in a directory to be updated, and generates a current hash value list. The backup management unit compares the generated hash value list with a hash value list recorded at the time of the previous backup. The backup management unit identifies only files whose hash values do not match. The backup management unit compresses the identified files into binary data blocks using a data compression algorithm. The backup management unit adds a unique version ID, a timestamp, and an identifier of an executing user to the binary data blocks as metadata. The backup management unit writes these to a version management repository on a non-volatile storage. The backup management unit inserts a summary text of change contents and the version ID in association with each other as a record into an update history database. When receiving a restoration request from an administrator terminal, the backup management unit reads a binary data block corresponding to a specified version ID from the repository. The backup management unit decompresses the binary data block and expands original files on a memory. The backup management unit overwrites corresponding files on a storage in a production environment with the expanded files. By adopting a differential backup method, the system minimizes consumption of storage capacity and I/O load required for backup processing. The system realizes high-speed rollback processing in milliseconds, and brings about a technical effect of minimizing site downtime. As a use case, it is applied to safe operation management in a mission-critical financial site or an EC site during a large-scale sale period when access is concentrated.

As described above, according to the embodiment of the present invention, simply by a person in charge of operating a mail-order site inputting a request in a natural language, generative AI utilizes past know-how and guidelines to automatically generate a plurality of high-quality update drafts, and while flexibly responding to a selection and an additional instruction by the person in charge and maintaining the quality and consistency of the entire site, it is possible to flexibly respond to various requirements required for modern mail-order site operation, such as SEO optimization, multilingual support, accessibility support, external service linkage, review display, related product recommendation, payment guide, campaign management, return policy, gift wrapping guide, sustainability information, and video embedding, and to realize a system with high future expandability and linkage with other systems. Specifically, the system includes an autonomous arithmetic pipeline integrating natural language processing, high-dimensional vector search, code generation by a large language model, and image generation AI. The system converts unstructured text input of a user into a multidimensional intent vector. The system dynamically extracts optimal context data from an internal asset database using the intent vector. The system combines the extracted data and the intent vector, and supplies them as an input tensor of a generative AI model. The generative AI model generates syntactically accurate HTML code, CSS code, and an optimized image tensor in parallel by autoregressive inference using billions of parameters. The system safely integrates the generated assets into an existing site structure by node manipulation at an abstract syntax tree level. The system automatically verifies and corrects link consistency of the entire site using a graph search algorithm. By combining these advanced computer processing methods, the system completely replaces conventional manual coding, design, and test work. The system simultaneously solves complex requirements such as SEO optimization, multilingual translation, and accessibility support within a single processing flow. The system brings about a technical improvement that dramatically improves processing speed, accuracy, and scalability in website operation. As a use case, it is applied to an autonomous operation system of an e-commerce platform of any scale, from a small or medium-sized enterprise without a specialized IT department to a global enterprise managing a huge amount of content.

### System Configuration

The system according to the present embodiment includes a user input unit, a site information acquisition unit, a generative AI processing unit, a draft presentation unit, an approval and reflection unit, and a backup management unit. The user input unit is a unit that provides an interface for a person in charge of operating a mail-order site to input which part of the site is to be changed and how in a natural language, operates on a terminal such as a personal computer, a tablet terminal, or a smartphone, for example, and includes various input means such as a text input field, a voice input function, an image attachment function, a file upload function, automatic completion of input content, presentation of an input example, typographical error check, and automatic display of a guideline according to the input content. Specifically, various requests can be input in Japanese or other languages or instructed by voice, such as “I want to add new product G. The product name is ‘cordless vacuum cleaner’, the price is 15,800 yen, the features are ‘lightweight, powerful suction, and long-time operation’, and the image file is cordless.jpg”, “I want to post this weekend's time sale ‘25% off all home appliances’ prominently on the top page”, “I want to add a question ‘When will points be awarded?’ and an answer ‘They will be awarded after shipping is completed’ to the FAQ”, “I want to make the expression of the delivery guide page easy for foreigners to understand”, “I want to change the review display to a type with images”, “I want to display the related product recommendation in a ranking type”, and “I want to add a payment method guide text in English and Chinese”. The user input unit transmits the input content to the server in real time, and provides an auxiliary function for ensuring the quality of the input content while reducing the input burden on the person in charge. Specifically, the system adopts a distributed processing architecture deployed as a group of virtual machine instances on a cloud environment. The user input unit is implemented as a JavaScript-based client application executed on a web browser of the terminal. The user input unit establishes a persistent bidirectional communication session with the server using a WebSocket protocol. The user input unit captures a keystroke event every time the user types a character in the text input field. The user input unit transmits a fragment of the input character string to the server in real time. A natural language processing engine on the server side inputs the received fragment of the character string to a recurrent neural network. The recurrent neural network calculates a probability distribution of a word that is highly likely to appear next while holding a hidden state vector of a past input sequence. The server returns a word string with the highest probability to the client as a predicted text vector. The user input unit decodes the predicted text vector and displays it as a placeholder in the input field. When voice input is selected, the user input unit streams PCM voice waveform data acquired from a microphone of the terminal to the server. A voice recognition model on the server side converts the voice waveform data into an acoustic feature tensor. The voice recognition model inputs the acoustic feature tensor to a Transformer-based decoder and converts it into a text character string. The system executes these advanced input support processes with low latency. The system significantly reduces a user's cognitive load and physical input operation amount. The system brings about a technical effect of improving the accuracy and comprehensiveness of input data supplied to the subsequent generative AI processing unit. As a use case, it is applied to an operation of a global EC site in which a complex update instruction in which multiple languages are mixed is quickly input by combining voice and text.

The site information acquisition unit is implemented on the server side, and is a unit that automatically searches for and acquires all internal assets related to mail-order site operation, such as past HTML files, CSS files, and JavaScript files of the mail-order site, a product database, a campaign history, FAQ data, delivery guide data, a design guideline, a brand color, a font specification, an image material, a banner template, an expression tone manual, a past banner image, a news article, design data delivered from an outsourcee, an API specification of an external service, an SEO countermeasure manual, an accessibility guideline, a review display template, a related product logic, a payment guide text template, multilingual support data, a return policy, terms of use, a gift wrapping guide, sustainability information, video embedding data, and an SNS linkage banner arrangement example. For example, it can also target for acquisition a layout and expression when a new product was added in the past, a posting pattern of sale information, a Q&A format and an explanation example with an illustration of an FAQ, a transition of expression of a delivery guide page, a brand color and a font specification, a design template of a banner image, an expression tone manual, a setting file for external service linkage, a past example of a title and a description for SEO optimization, an example of adding an alt attribute and an aria label for accessibility support, each pattern of star rating, comment, and with image of review display, each draft of side-by-side type, carousel type, pop-up type, ranking type, and AI personalized type of related product recommendation, a multilingual support example such as Japanese, English, and Chinese of a payment guide text, a limited banner during a campaign period and an automatic switching scheduling example, a past arrangement order and category configuration of a product list page, a posting method of a review and word of mouth, a recommendation logic of a related product, a linkage specification with an external payment service, an API specification of an external delivery service, a past version of a return policy and terms of use, an expression example of a gift wrapping guide, a posting example of sustainability information, a past case of video embedding, and an arrangement example of an SNS linkage banner. The site information acquisition unit provides these pieces of information to the generative AI processing unit, and supports generation of an optimal draft by AI. Specifically, the site information acquisition unit includes a plurality of data collection agents. The data collection agent connects to a storage node on a designated internal network using an asynchronous communication protocol. The site information acquisition unit parses the acquired various files. The site information acquisition unit executes preprocessing for removing unnecessary tags and control characters from text data. The site information acquisition unit inputs the preprocessed text data to a natural language processing model. The natural language processing model converts the input text data into a token array. The natural language processing model generates a 768-dimensional dense vector from the token array. The site information acquisition unit executes resize processing and normalization processing on image data. The site information acquisition unit inputs the normalized image data to a convolutional neural network. The convolutional neural network extracts a 512-dimensional feature vector from the image data. The site information acquisition unit stores the generated various vector data in a vector database. The vector database constructs an index in a high-dimensional space. The site information acquisition unit executes an approximate nearest neighbor search on the vector database in response to an input request from a user. The approximate nearest neighbor search uses cosine similarity as a calculation criterion. The site information acquisition unit extracts past internal asset data whose similarity exceeds a predetermined threshold. By this extraction processing, the system identifies an optimal asset matching a context from a huge amount of unstructured data in milliseconds. This processing eliminates manual search work by a human. This processing optimizes memory usage efficiency of a computer. This processing brings about a technical effect of significantly reducing search latency. This configuration is applied to a reuse process of past design assets and code assets in a large-scale e-commerce platform.

The generative AI processing unit is implemented on the server side, and is a unit that receives desired content in a natural language transmitted from the user input unit and various internal assets acquired by the site information acquisition unit as input information, and automatically generates a plurality of mail-order site update drafts by combining generative AI, that is, a large language model, image generation AI, code generation AI, layout optimization AI, expression tone determination AI, SEO optimization AI, accessibility check AI, multilingual translation AI, and the like. For example, in the case of adding a new product, it generates drafts with different layouts and expressions, such as “Draft 1: Post product description mainly with text, and arrange image on the right side”, “Draft 2: Emphasize features with bullet points, and arrange image large in the center”, “Draft 3: Emphasize lightweight, powerful suction, and long-time operation in a banner style, and set a link to a catalog PDF under the product image”, “Draft 4: Automatically generate SEO-optimized title and description, and display related product recommendation in a ranking type”, and “Draft 5: Arrange review display in a type with images at the bottom”. In the case of sale information, it generates a plurality of drafts, such as “Draft 1: Post sale information in a banner area of the top page”, “Draft 2: Display sale information in a pop-up”, “Draft 3: Add sale information to a news column, and guide with a banner”, “Draft 4: Set scheduling to automatically return to the original banner after the sale period ends”, and “Draft 5: Display an SNS linkage banner at the same time”. In the case of an FAQ, it generates drafts including differences in expression methods, such as “Draft 1: Add in a Q&A format”, “Draft 2: Explain with an illustration”, “Draft 3: Insert a video link”, “Draft 4: Automatically generate English and Chinese pages with multilingual support”, and “Draft 5: Automatically add text for voice reading with accessibility support”. In the case of a delivery guide, it automatically generates drafts tailored to a user layer and operation requirements, such as “Draft 1: Modify text concisely”, “Draft 2: Explain with an illustration”, “Draft 3: Organize in a table format”, “Draft 4: Automatically generate English and Chinese pages for foreigners”, and “Draft 5: Automatically generate an API linkage guide of an external delivery service”. Furthermore, the generative AI can also automatically create drafts for SEO optimization drafts of product pages, variations of review display methods, display patterns of related product recommendations, differences in expression of payment method guide texts, automatic generation of limited banners during a campaign period, automatic generation of multilingual support pages, automatic check and modification draft generation for accessibility support, automatic generation of SNS linkage banners, automatic generation of video embedding drafts, differences in expression of gift wrapping guides, posting drafts of sustainability information, and automatic update drafts of return policies and terms of use. Specific examples of prompt sentences to be read by the generative AI include “Please add new product G ‘cordless vacuum cleaner’ to the product page. The price is 15,800 yen, the features are lightweight, powerful suction, and long-time operation, use the image file cordless.jpg, and match the layout of existing products”, “Please post this weekend's time sale ‘25% off all home appliances’ prominently on the top page. Please create both banner and pop-up drafts”, “Please add a question ‘When will points be awarded?’ and an answer ‘They will be awarded after shipping is completed’ to the FAQ. Please create drafts in a Q&A format and with an illustration”, “Please modify the expression of the delivery guide page so that it is easy for foreigners to understand. Please also automatically generate English and Chinese pages”, “Please change the review display to a type with images”, “Please display the related product recommendation in a ranking type”, “Please add a payment method guide text in English and Chinese”, “Please generate a plurality of optimization drafts for titles and descriptions to strengthen SEO of product pages”, “Please automatically update the return policy to content compliant with the latest laws and regulations”, “Please add a gift wrapping guide with an easy-to-understand illustration”, “Please add sustainability information to the bottom of the product page”, and “Please create a video embedding draft”. Specifically, the generative AI processing unit has an ensemble architecture integrating a plurality of neural network models. The generative AI processing unit expands a Transformer-based large language model on a memory. The generative AI processing unit includes a diffusion model-based image generation model. The generative AI processing unit converts a natural language text received from the user input unit into an array of numerical IDs using a tokenizer. The generative AI processing unit acquires an embedding vector of a past asset provided from the site information acquisition unit. The generative AI processing unit combines the array of numerical IDs and the embedding vector to generate an integrated input tensor. The integrated input tensor is, for example, matrix data having a sequence length of 2048 and a hidden layer dimension number of 1024. The generative AI processing unit inputs the integrated input tensor to an encoder layer of the large language model. The large language model calculates a dependency relationship between each element in the input data using a self-attention mechanism. The large language model outputs an appearance probability distribution of a next token through a decoder layer. The generative AI processing unit generates a text stream of HTML code or CSS code based on the probability distribution. The generative AI processing unit inputs a text prompt and a noise tensor to the image generation model. The image generation model iteratively executes an operation of a reverse diffusion process. The image generation model finally outputs an image tensor having each RGB channel. The generative AI processing unit executes subsequent processing of determining the presence or absence of a grammatical error for the output code using a parser. The generative AI processing unit executes subsequent processing of generating high-resolution image data by applying a super-resolution model to the output image tensor. By these processes, the system completely replaces manual work by a human programmer or designer. The system generates a plurality of design drafts in parallel and at high speed by a non-linear matrix operation in a high-dimensional space. This processing exhibits a technical effect of dramatically shortening the time required for content generation. This configuration is applied to an operation task of an online shopping site where frequent page updates are required.

The draft presentation unit is implemented on the terminal side, and is a unit that presents the plurality of mail-order site update drafts generated by the generative AI processing unit to the person in charge as preview images or HTML files. For example, it displays five new product page drafts and preview images of product list pages corresponding to each side by side so that the person in charge can intuitively compare and select them. In the case of adding sale information, it displays a banner draft, a pop-up draft, a news column draft, an SNS linkage draft, and a scheduling draft side by side so that differences in design and appeal can be confirmed. In the case of adding an FAQ, a Q&A format draft, a draft with an illustration, a draft with a video link, a multilingual support draft, and an accessibility support draft can be compared. In the case of modifying a delivery guide, a text modified version, a draft with an illustration, a table format draft, a draft for foreigners, and an external delivery service linkage draft are displayed side by side so that ease of understanding and design can be compared. In the case of review display, it presents a plurality of drafts, such as a type with images, a star rating type, a comment-only type, a type with video, and an SNS linkage type. In the case of related product recommendation, it presents a plurality of drafts, such as a ranking type, a side-by-side type, a carousel type, a pop-up type, and an AI personalized type. The person in charge can select a draft that best matches the desired content, or input a more detailed modification instruction in a natural language. For example, additional requests can be input, such as “I want the feature column to stand out more”, “I want the banner color to be the brand color”, “I want the FAQ answer to be a little more detailed”, “I want the delivery guide illustration to be larger”, “I want the review display to be a type with video”, “I want the related product recommendation to be an AI personalized type”, “I want the payment guide text to be added in Chinese as well”, “I want an illustration to be added to the return policy”, “I want the gift wrapping guide to be added with a video”, and “I want the sustainability information to be displayed with a graph”. These additional instructions are also transmitted to the generative AI processing unit again, and a modified version of the draft is regenerated. Furthermore, even when the person in charge additionally uploads an image, a PDF, a video file, or the like, the AI automatically performs optimal layout and link setting, and reflects them in the draft. Specifically, the draft presentation unit includes a hardware acceleration rendering engine utilizing a graphics processing unit of a client terminal. The draft presentation unit receives metadata in JSON format and an HTML payload from the server. The draft presentation unit constructs a virtual document object model on a memory based on the received data. The draft presentation unit calculates a difference between the virtual document object model and a current display screen. The draft presentation unit renders only difference data to a physical screen. The draft presentation unit executes multi-thread processing for drawing a plurality of update drafts in parallel. The draft presentation unit acquires a modification instruction text from the user. The draft presentation unit inputs the modification instruction text to a natural language processing module. The natural language processing module extracts a feature vector from the modification instruction text. The draft presentation unit transmits the extracted feature vector to the generative AI processing unit on the server side as feedback data. The generative AI processing unit recalculates an attention map for an existing generation result using the feedback data. The generative AI processing unit regenerates a modified version of the draft based on the recalculated attention map. The system minimizes network traffic and drawing latency by differential rendering using the virtual document object model. The system avoids a regeneration operation from scratch by a feedback loop. This processing brings about a technical effect of significantly reducing calculation resource consumption on the server side. This configuration is applied to an interactive authoring tool for comparing and examining a plurality of design variations in real time.

The approval and reflection unit is implemented on the server side, and is a unit that automatically reflects the update draft finally approved by the person in charge in an existing mail-order site page. The generative AI analyzes existing HTML, CSS, and JavaScript files to safely and accurately rewrite only a designated portion. For example, a new product is automatically added to a product list page or a new arrival column of a top page, sale information is displayed as a banner or a pop-up, and an FAQ page or a delivery guide page is updated to the latest content. Review display, related product recommendation, payment guide text, return policy, gift wrapping guide, sustainability information, video embedding, and the like are also automatically reflected based on the designated draft. Furthermore, the AI automatically checks consistency of links and navigation across a plurality of pages, and modifies related pages as necessary. For example, when a new product is added, a link and an introduction text are automatically added to a related product page, a recommended product column, and a pickup column of the top page. When sale information is added, scheduling to automatically return to the original banner after the campaign period ends is also possible. Multilingual support pages for FAQs and delivery guides are also automatically generated, and links in navigation and footers are automatically updated. Specifically, the approval and reflection unit includes an automated deployment pipeline module. The approval and reflection unit converts HTML code and JavaScript code of the approved update draft into an abstract syntax tree. The approval and reflection unit similarly converts source code of an existing website into an abstract syntax tree. The approval and reflection unit compares both abstract syntax trees to identify a group of nodes that need to be changed. The approval and reflection unit executes safe replacement processing only for the identified group of nodes. The approval and reflection unit holds directed graph data representing a link structure of the entire site on a memory. The approval and reflection unit applies a depth-first search algorithm to the directed graph data. The approval and reflection unit detects all link source nodes depending on a newly added page or a changed URL. The approval and reflection unit automatically rewrites HTML attribute values of the detected link source nodes. The approval and reflection unit executes an automatic test script on the updated files. The automatic test script detects a broken link or a broken layout. The approval and reflection unit transfers the files that have passed the test to a web server in a production environment. The system completely eliminates a syntax error that can occur in simple character string replacement by code replacement using the abstract syntax tree. The system mathematically guarantees consistency of the entire site by the graph search algorithm. This processing prevents a human error during deployment. This processing exhibits a technical effect of bringing website downtime close to zero. This configuration is applied to operation management of a large-scale portal site having a complex hierarchical structure of a scale of thousands of pages.

The backup management unit is implemented on the server side, and is a unit that automatically saves a complete set of current mail-order site pages as a backup before executing an update operation. It saves all related files constituting the mail-order site, such as HTML files, CSS files, JavaScript files, image files, PDF materials, video files, and setting files for external service linkage, with time information, and performs past version management. Thereby, even if a defect occurs after an update in an emergency, it can be restored to an original state with one click. Furthermore, it records all update histories so that who made what changes and when can be confirmed from a management screen. For example, detailed histories can be displayed in chronological order, such as “Jun. 1, 2024 10:00 New product G added”, “Jun. 2, 2024 15:30 Time sale posted”, “Jun. 3, 2024 9:00 FAQ modified”, “Jun. 4, 2024 11:00 Delivery guide updated”, “Jun. 5, 2024 13:00 Review display changed”, “Jun. 6, 2024 14:00 Related product recommendation changed”, “Jun. 7, 2024 16:00 Payment guide text added”, “Jun. 8, 2024 17:00 Return policy updated”, “Jun. 9, 2024 18:00 Gift wrapping guide added”, “Jun. 10, 2024 19:00 Sustainability information added”, and “Jun. 11, 2024 20:00 Video embedding added”. Specifically, the backup management unit includes a data management module linked with a distributed object storage system. The backup management unit scans all files to be updated. The backup management unit applies a SHA256 hash function to the content of each file. The backup management unit generates the calculated hash value as a unique identifier. The backup management unit collates the generated hash value with an existing backup catalog. The backup management unit extracts only changed files whose hash values do not match. The backup management unit applies a lossless compression algorithm to the extracted files. The backup management unit transfers compressed data blocks to the distributed object storage. The backup management unit generates a metadata record including a timestamp, a user ID, and a hash value list of the changed files. The backup management unit stores the metadata record in a relational database. When receiving a restoration request, the backup management unit searches for a corresponding metadata record. The backup management unit acquires necessary data blocks from the distributed object storage based on the hash value list. The backup management unit decompresses the data blocks and reconstructs original files. The system dramatically reduces consumption capacity of storage by hash-based deduplication processing. The system minimizes occupation of network bandwidth by transferring only differential data. This processing brings about a technical effect of eliminating an IO bottleneck of backup and restoration processing. This configuration is applied to an enterprise content management system in which frequent content updates occur and a strict audit trail is required.

As described above, the system according to the present embodiment has the user input unit, the site information acquisition unit, the generative AI processing unit, the draft presentation unit, the approval and reflection unit, and the backup management unit, each of which corresponds to specific and diverse cases, eliminates personalization of the mail-order site with the generative AI as a core, and is configured so that anyone can easily realize high-quality mail-order site update. Specific examples of prompt sentences to be read by the generative AI include “Please add new product G ‘cordless vacuum cleaner’ to the product page. The price is 15,800 yen, the features are lightweight, powerful suction, and long-time operation, use the image file cordless.jpg, and match the layout of existing products”, “Please post this weekend's time sale ‘25% off all home appliances’ prominently on the top page. Please create both banner and pop-up drafts”, “Please add a question ‘When will points be awarded?’ and an answer ‘They will be awarded after shipping is completed’ to the FAQ. Please create drafts in a Q&A format and with an illustration”, “Please modify the expression of the delivery guide page so that it is easy for foreigners to understand. Please also automatically generate English and Chinese pages”, “Please change the review display to a type with images”, “Please display the related product recommendation in a ranking type”, “Please add a payment method guide text in English and Chinese”, “Please generate a plurality of optimization drafts for titles and descriptions to strengthen SEO of product pages”, “Please automatically update the return policy to content compliant with the latest laws and regulations”, “Please add a gift wrapping guide with an easy-to-understand illustration”, “Please add sustainability information to the bottom of the product page”, and “Please create a video embedding draft”, and by these prompt sentences, the generative AI can maximize the use of internal assets and automatically generate an optimal mail-order site update draft. Specifically, the system is constructed on a distributed processing platform adopting a microservice architecture. The system executes each processing unit as an independent container. The system dynamically controls resource allocation of each processing unit using a container orchestration tool. The system uses a message queuing system for data communication between the processing units. The system implements an asynchronous communication protocol based on a publish-subscribe model. The system publishes a request from the user input unit to a message queue. In the system, the site information acquisition unit and the generative AI processing unit subscribe to the request from the message queue and start parallel processing. The system drives a parallel arithmetic cluster bundling a plurality of GPU nodes in the generative AI processing unit. The system executes tensor parallel processing for dividing and arranging weight parameters of a large language model into a plurality of GPU memories. The system executes a matrix multiplication operation at high speed in a distributed environment in response to input of a prompt sentence. By loosely coupling each module, the system prevents delay of the entire system even when a load is concentrated on a specific processing unit. The system includes a self-healing function of automatically restarting a container on another node when a hardware failure occurs. This processing dramatically improves fault tolerance of the entire system. This processing exhibits a technical effect of maintaining a stable response speed even under a high load. This configuration is applied to a global-scale e-commerce infrastructure in which traffic fluctuates drastically and 24/7 non-stop operation is required.

### Implementation Steps

Step 1: Request Input Step A person in charge of operating a mail-order site inputs which part of the site is to be changed and how in a natural language using a user interface of a terminal. For example, requests can be input by various means such as text input, voice input, image attachment, and file upload, such as “I want to add a new product H. The product name is ‘smart humidifier’, the price is 9,800 yen, the features are ‘Wi-Fi compatible, automatic humidity adjustment, and energy saving’, and the image file is smart_humid.jpg”, “I want to post this weekend's time sale ‘30% off all items’ prominently on the top page”, “I want to add a question ‘Is it possible to change after ordering?’ and an answer ‘It is possible before shipping’ to the FAQ”, “I want to make the expression of the delivery guide page easy for foreigners to understand”, “I want to change the review display to a combined star rating and comment type”, “I want to display related product recommendations in a carousel type”, and “I want to add a payment method guide text in English and Chinese”. The input content is transmitted to a server in real time. Specifically, in this request input step, a client application on the terminal side executes a preprocessing module for input data. The client application applies a morphological analysis algorithm to the natural language text input by the user. The client application divides the text data into word or phrase tokens. When voice input is selected, the client application digitally samples an analog audio signal acquired from a built-in microphone. The client application executes a fast Fourier transform on the digital audio data to generate frequency spectrum data. The client application inputs the frequency spectrum data to an acoustic neural network model. The acoustic neural network model infers and outputs text data from audio features. When an image file is attached, the client application encodes the image data into a base64 format character string. The client application packages the encoded image data and the text tokens into a JSON format payload. The client application establishes secure WebSocket communication. The client application asynchronously streams and transmits the packaged payload to the server. The present system significantly reduces a parsing processing load on the server side by executing advanced preprocessing on the client side. The present system optimizes a communication payload size by data compression and encoding. This process brings about a technical effect of realizing real-time data transmission while suppressing consumption of a network bandwidth. This configuration is applied to a multi-platform compatible business application that supports various input devices.

Step 2: Automatic Site Information Collection Step A site information acquisition unit automatically searches for and acquires all internal assets related to mail-order site operation, such as past HTML files, CSS files, and JavaScript files of the mail-order site, a product database, a campaign history, FAQ data, delivery guide data, a design guideline, a brand color, a font specification, an image material, a banner template, an expression tone manual, a past banner image, a news article, design data delivered from an external contractor, an API specification of an external service, an SEO countermeasure manual, an accessibility guideline, a review display template, a related product logic, a payment guide text template, multilingual support data, a return policy, terms of use, a gift wrapping guide, sustainability information, video embedding data, and an SNS linkage banner arrangement example. For example, layouts and expressions when adding past new products, posting patterns of sale information, Q&A formats and explanation examples with illustrations of FAQs, transitions of expressions of delivery guide pages, brand colors and font specifications, design templates of banner images, expression tone manuals, setting files for external service linkage, past examples of titles and descriptions for SEO optimization, examples of adding alt attributes and aria labels for accessibility support, respective patterns of review displays with star ratings, comments, and images, respective drafts of related product recommendations of a side-by-side type, a carousel type, a pop-up type, a ranking type, and an AI personalized type, multilingual support examples of payment guide texts such as Japanese, English, and Chinese, limited banners and automatic switching scheduling examples during a campaign period, past arrangement orders and category configurations of product list pages, posting methods of reviews and word-of-mouth, recommendation logics of related products, linkage specifications with external payment services, API specifications of external delivery services, past versions of return policies and terms of use, expression examples of gift wrapping guides, posting examples of sustainability information, past examples of video embedding, and arrangement examples of SNS linkage banners can also be acquisition targets. Specifically, in this automatic site information collection step, a crawler module on the server side executes parallel access to a plurality of data sources on an internal network. The crawler module inputs unstructured data acquired from each data source to a normalization pipeline. The normalization pipeline constructs a DOM tree from an HTML file and extracts only text nodes. The normalization pipeline inputs the extracted text data to an embedding model. The embedding model maps the text data to coordinate points on a 768-dimensional dense vector space. The normalization pipeline applies a feature extractor to image data to generate a 512-dimensional image feature vector. The server registers all the generated vector data in a vector database having a high-dimensional index structure. The server similarly vectorizes the user's request input text to generate a query vector. The server calculates a cosine similarity between the query vector and the registered vector group on the vector database. The server instantaneously identifies internal asset data corresponding to the top N similarity scores and loads it onto a memory. The present system adopts a search algorithm based on a semantic distance in a high-dimensional vector space instead of a conventional keyword matching search. The present system absorbs orthographical variants and differences in synonyms to accurately extract data matching the context. This process dramatically improves search accuracy. This process exhibits a technical effect of avoiding a full scan of the database and shortening a search latency to the order of milliseconds. This configuration is applied to a large-scale knowledge management system that accumulates an enormous amount of past operation histories and design assets.

Step 3: Draft Generation Step by Generative AI A generative AI processing unit receives the desired content in the natural language input in the request input step and the various internal assets acquired in the automatic site information collection step as input information, and automatically generates a plurality of mail-order site update drafts by combining a large language model, image generation AI, code generation AI, layout optimization AI, expression tone determination AI, SEO optimization AI, accessibility check AI, multilingual translation AI, and the like. For example, in the case of adding a new product, it generates drafts with different layouts and expressions, such as “Draft 1: Post product description mainly with text, and arrange image on the right side”, “Draft 2: Emphasize features with bullet points, and arrange large image in the center”, “Draft 3: Emphasize Wi-Fi compatible, automatic humidity adjustment, and energy saving in a banner style, and install a link to a catalog PDF below the product image”, “Draft 4: Automatically generate SEO-optimized title and description, and display related product recommendations in a carousel type”, and “Draft 5: Arrange review display at the bottom in a combined star rating and comment type”. Specific examples of prompt sentences to be read by the generative AI include “Please add a new product H ‘smart humidifier’ to the product page. The price is 9,800 yen, the features are Wi-Fi compatible, automatic humidity adjustment, and energy saving, use the image file smart_humid.jpg, and match the layout of existing products”, “Please post this weekend's time sale ‘30% off all items’ prominently on the top page. Please create drafts for both a banner and a pop-up”, “Please add a question ‘Is it possible to change after ordering?’ and an answer ‘It is possible before shipping’ to the FAQ. Please create drafts with a Q&A format and illustrations”, “Please modify the expression of the delivery guide page to be easy for foreigners to understand. Please also automatically generate English and Chinese pages”, “Please change the review display to a combined star rating and comment type”, “Please display related product recommendations in a carousel type”, “Please add a payment method guide text in English and Chinese”, “Please generate a plurality of optimization drafts for the title and description to strengthen the SEO of the product page”, “Please automatically update the return policy to content compliant with the latest laws and regulations”, “Please add a gift wrapping guide with easy-to-understand illustrations”, “Please add sustainability information to the bottom of the product page”, and “Please create a video embedding draft”. Specifically, in this draft generation step, the generative AI processing unit drives an integrated neural network architecture that processes multimodal input data. The generative AI processing unit combines the user's request text vector and the context vector of the collected internal assets. The generative AI processing unit inputs the combined vector data to an encoder layer of a transformer model. The encoder layer weights and calculates the relevance between each token in the input sequence using a multi-head attention mechanism. The generative AI processing unit passes the output representation of the encoder to a decoder layer. The decoder layer repeatedly executes an autoregressive operation. The decoder layer outputs a probability distribution score for the entire vocabulary space. The generative AI processing unit sequentially selects tokens with the highest probability to generate structured text data including HTML tags and CSS properties. The generative AI processing unit activates a latent diffusion model in an image generation task. The latent diffusion model sets a random Gaussian noise tensor as an initial state. The latent diffusion model applies a denoising network over a plurality of steps based on a conditioning vector of a text prompt. The latent diffusion model finally outputs a pixel tensor of a high-quality product image or banner image. The generative AI processing unit integrates the output text data and image tensor to construct a complete source code set of a web page. The present system converts design conception and coding work, which are human mental processes, into a purely physical operation process of matrix multiplication operations having hundreds of millions of parameters and application of non-linear activation functions. This process brings about a technical effect of generating a plurality of design variations in parallel with a speed and comprehensiveness impossible for humans. This configuration is applied to a next-generation web publishing system that generates personalized dynamic content in real time.

Step 4: Draft Presentation and Additional Instruction Step A draft presentation unit presents the plurality of mail-order site update drafts generated by the generative AI processing unit to the person in charge as preview images or HTML files. For example, it displays five drafts of new product pages and preview images of product list pages corresponding to each side by side so that the person in charge can intuitively compare and select them. In the case of adding sale information, it displays a banner draft, a pop-up draft, a news column draft, an SNS linkage draft, and a scheduling draft side by side so that differences in design and appeal can be confirmed. In the case of adding an FAQ, a Q&A format draft, a draft with illustrations, a draft with a video link, a multilingual support draft, and an accessibility support draft can be compared. In the case of modifying a delivery guide, a text modified version, a draft with illustrations, a tabular format draft, a draft for foreigners, and an external delivery service linkage draft are displayed side by side so that ease of understanding and design can be compared. In the case of a review display, a plurality of drafts such as a type with images, a star rating type, a comment-only type, a type with videos, and an SNS linkage type are presented. In the case of a related product recommendation, a plurality of drafts such as a ranking type, a side-by-side type, a carousel type, a pop-up type, and an AI personalized type are presented. The person in charge can select a draft that best matches the desired content or input a finer modification instruction in a natural language. For example, additional requests can be input, such as “I want the feature column to stand out more”, “I want the banner color to be the brand color”, “I want the FAQ answer to be a little more detailed”, “I want the illustration of the delivery guide to be larger”, “I want the review display to be a type with videos”, “I want the related product recommendation to be an AI personalized type”, “I want the payment guide text to be added in Chinese as well”, “I want illustrations to be added to the return policy”, “I want the gift wrapping guide to be added with a video”, and “I want the sustainability information to be displayed with a graph”. These additional instructions are also transmitted to the generative AI processing unit again, and a modified version of the draft is regenerated. Specifically, in this draft presentation and additional instruction step, a rendering engine on the terminal side expands the received plurality of HTML files and image data onto a virtual canvas on a memory. The rendering engine rasterizes a plurality of preview screens in parallel using a shader program of a GPU. The rendering engine maintains smooth drawing at 60 frames per second in response to a user's scroll or zoom operation. The terminal detects that the user has selected a specific draft and input an additional modification instruction text. The terminal transmits an identifier of the selected draft and the modification instruction text to the server. The generative AI processing unit on the server side vectorizes the received modification instruction text. The generative AI processing unit restores an existing internal state tensor of the selected draft from the memory. The generative AI processing unit adds a modification instruction vector as a conditioning signal to the existing internal state tensor. The generative AI processing unit locally updates weights of a specific code block or image region to be modified using a cross-attention mechanism. The generative AI processing unit regenerates only code or image data that is a difference based on the updated weights. The present system avoids complete re-inference from scratch. The present system reuses the internal state tensor which is an existing calculation result. This process significantly reduces consumption of calculation resources required for regeneration. This process exhibits a technical effect of dramatically shortening a response time to the user. This configuration is applied to an AI-assisted design tool that refines creative deliverables through an interactive feedback loop.

Step 5: Approval and Reflection Step An approval and reflection unit automatically reflects the update draft finally approved by the person in charge in an existing mail-order site page. The generative AI analyzes existing HTML, CSS, and JavaScript files to safely and accurately rewrite only a designated portion. For example, a new product is automatically added to a product list page or a new arrival column of a top page, sale information is displayed as a banner or a pop-up, and an FAQ page or a delivery guide page is updated to the latest content. A review display, a related product recommendation, a payment guide text, a return policy, a gift wrapping guide, sustainability information, video embedding, and the like are also automatically reflected based on the designated draft. Furthermore, the AI automatically checks consistency of links and navigation across a plurality of pages, and modifies related pages as necessary. Specifically, in this approval and reflection step, a deployment controller on the server side starts an atomic transaction process. The deployment controller expands a source code group of the approved update draft to a temporary staging directory. The deployment controller acquires an exclusive lock on a file system of the existing website. The deployment controller overwrites a file to be updated with a file in the staging directory. The deployment controller constructs a directed acyclic graph representing dependencies of all pages in the site on a memory. The deployment controller executes a graph search algorithm that starts from an updated node and traces edges. The deployment controller identifies all affected related pages. The deployment controller parses HTML files of the identified related pages to automatically rewrite elements of link URLs and navigation menus. The deployment controller confirms that all rewriting processes have been completed normally. The deployment controller releases the exclusive lock and commits the transaction. When detecting an error during the process, the deployment controller immediately executes a rollback process to restore the file system to an original state. The present system combines atomic transaction management and a dependency resolution algorithm based on graph theory. The present system mathematically eliminates occurrence of data inconsistency and broken links in a complex update work across a plurality of pages. This process brings about a technical effect of strictly maintaining availability and integrity of the website. This configuration is applied to a large-scale corporate site or a web portal of a financial institution that provides mission-critical information.

Step 6: Backup and History Management Step A backup management unit automatically saves a set of current mail-order site pages as a backup before executing an update work. It saves all related files constituting the mail-order site, such as HTML files, CSS files, JavaScript files, image files, PDF materials, video files, and setting files for external service linkage, with time information, and performs past version management. Thereby, even if a defect occurs after the update, it can be restored to an original state with one click in an emergency. Furthermore, it records all update histories so that who made what changes and when can be confirmed from a management screen. Specifically, in this backup and history management step, a storage management daemon on the server side intercepts a start signal of an update transaction. The storage management daemon activates a snapshot creation process of an entire target directory tree. The storage management daemon uses a copy-on-write technology at a file system level. The storage management daemon instantaneously generates a logical backup point without performing physical data replication. The storage management daemon executes a block-level difference extraction algorithm with a previous snapshot. The storage management daemon identifies only changed data blocks. The storage management daemon applies a high-speed lossless compression algorithm such as LZ4 to the identified data blocks. The storage management daemon writes the compressed block data to a persistent storage. The storage management daemon records a timestamp of the snapshot, an authentication token of an executing user, and a summary hash value of changed content as metadata in a distributed ledger database. The present system combines the copy-on-write technology and a block-level differential backup. The present system minimizes a disk IO load and consumption of a storage capacity accompanying a backup process to the utmost limit. The present system cryptographically prevents falsification of history data using the distributed ledger database. This process exhibits a technical effect of securing a complete audit trail while preventing a decrease in system performance. This configuration is applied to an electronic commerce system or a web platform of a public institution that requires strict compliance requirements. (Specific Use Case)

For example, a use case of adding a new product “multifunctional steam iron” to a mail-order site is assumed. In this case, a person in charge of operation inputs “I want to add a new product ‘multifunctional steam iron’ to the product page. The price is 14,800 yen, the features are ‘cordless, automatic temperature adjustment, and lightweight design’, the image file is steam_iron.jpg, and the catalog PDF is catalog_steam.pdf” in a natural language through a user input unit. The input content is transmitted to a server, and a site information acquisition unit automatically collects HTML layouts when adding past new products, configurations of product list pages, brand colors and font specifications, explanatory texts and image arrangements of existing products, recommendation logics of related products, SEO countermeasure manuals, review display templates, design templates of banner images, expression examples of related FAQs and delivery guides, and the like. Specifically, in this use case, the user input unit acquires the natural language text of the person in charge as character string data. The user input unit transmits the character string data to a natural language processing pipeline on the server side. The natural language processing pipeline tokenizes the character string data and converts it into a 768-dimensional dense vector. The server receives an image file and a PDF file as a binary stream. The server extracts a 512-dimensional visual feature vector from the image file. The server extracts a text layer from the PDF file and similarly converts it into a dense vector. The site information acquisition unit inputs each generated vector as a query to a vector database. The site information acquisition unit executes a K-nearest neighbor algorithm. The site information acquisition unit searches past HTML layout data and metadata of brand guidelines whose cosine similarity exceeds a predetermined threshold at high speed. The site information acquisition unit constructs the searched data as a JSON format context object on a memory. The present system maps the input multimodal data (text, image, PDF) to a common high-dimensional vector space. The present system mathematically calculates a semantic relevance between heterogeneous data. This process realizes highly accurate asset extraction matching a context, which is impossible with a simple keyword search. This process brings about a technical effect of dramatically improving input quality of a subsequent AI generation process. This configuration is applied to a large-scale product information management system in which product materials of various formats are mixed.

A generative AI processing unit automatically generates drafts with different layouts and expressions based on the request of the person in charge and the data collected by the site information acquisition unit, such as “Draft 1: Post product description mainly with text, and arrange image on the right side”, “Draft 2: Emphasize features with bullet points, and arrange large image in the center”, “Draft 3: Emphasize cordless, automatic temperature adjustment, and lightweight design in a banner style, and install a link to a catalog PDF below the product image”, “Draft 4: Automatically generate SEO-optimized title and description, and display related product recommendations in a carousel type”, and “Draft 5: Arrange review display at the bottom in a combined star rating and comment type”. Specific examples of prompt sentences to be read by the generative AI include “Please add a new product ‘multifunctional steam iron’ to the product page. The price is 14,800 yen, the features are cordless, automatic temperature adjustment, and lightweight design, use the image file steam_iron.jpg and the catalog PDF catalog_steam.pdf, and match the layout of existing products”, “Please generate a plurality of optimization drafts for the title and description to strengthen the SEO of the product page”, “Please change the review display to a combined star rating and comment type”, and “Please display related product recommendations in a carousel type”. Specifically, in this use case, the generative AI processing unit combines the prompt sentence and the context object to construct a huge input tensor. The generative AI processing unit inputs the input tensor to a transformer-based language model having billions of parameters. The language model executes a multi-head attention operation in an encoder layer. The language model calculates a hidden correlation between feature keywords such as “cordless” and “automatic temperature adjustment” in the input data and a past layout structure using a learned weight matrix. The language model autoregressively predicts a probability distribution of a next token in a decoder layer. The language model searches for a token sequence with the highest likelihood using a beam search algorithm. The language model generates a source code including HTML tags, CSS class names, and optimized text. The generative AI processing unit simultaneously activates an SEO optimization module. The SEO optimization module calculates an appearance frequency of important keywords from the generated text using a TF-IDF algorithm. The SEO optimization module automatically adjusts character strings of a title tag and a meta description to conform to an index algorithm of a search engine. The present system integrates advanced natural language processing and a heuristic SEO algorithm. The present system generates an output that simultaneously satisfies a plurality of objective functions of design aesthetics and search engine optimization. This process exhibits a technical effect of completing a work that takes a human coder or marketer several hours by a computer process of several seconds. This configuration is applied to a content generation pipeline of a highly competitive EC site where maximization of search inflow is directly linked to sales.

The draft presentation unit presents the generated plurality of drafts to the person in charge as preview images or HTML files, and the person in charge can input additional requests in a natural language, such as “I want the feature section to stand out more,” “I want the banner color to be the brand color,” “I want the review display to be an image-attached type,” and “I want the related product recommendation to be an AI-personalized type.” These additional instructions are also transmitted to the generative AI processing unit again, and a modified version of the draft is regenerated. Specifically, in this use case, the draft presentation unit loads the generated HTML files and image data into a browser engine of the client terminal. The browser engine constructs a DOM tree and draws a preview screen through a rendering pipeline. The terminal acquires text data of the additional request input by the person in charge. The terminal transmits the additional request text to the server. The generative AI processing unit on the server side vectorizes the additional request text. The generative AI processing unit reads an activation tensor of a hidden layer of a neural network cached in a memory in the previous generation process. The generative AI processing unit injects an additional request vector into the activation tensor using a cross-attention mechanism. The generative AI processing unit locally amplifies a weight parameter of a CSS property (font size or background color) corresponding to the instruction “make the feature section stand out.” The generative AI processing unit regenerates only a code snippet of a corresponding DOM node based on the changed weight. The system adopts a stateful inference architecture that reuses the cached activation tensor. The system omits recalculation of the entire network. This process reduces inference latency to a millisecond order. This process brings about a technical effect of eliminating user waiting time in an interactive operation. This configuration is applied to a professional web design tool in which real-time feedback is indispensable.

Regarding the draft finally approved by the person in charge, the approval and reflection unit automatically reflects it in an existing mail-order site page. The generative AI analyzes existing HTML, CSS, and JavaScript files to safely and accurately rewrite only a specified portion, a new product is automatically added to a product list page or a new arrival section of a top page, and a link and an introduction text are also automatically added to a related product page, a recommended product section, and a pickup section of the top page. The review display and the related product recommendation are also automatically reflected based on the specified draft. Furthermore, an SEO-optimized title and description are also automatically set. Specifically, in this use case, the approval and reflection unit expands an HTML code of the approved new product page as an abstract syntax tree on a memory. The approval and reflection unit also converts source codes of the existing product list page and top page into abstract syntax trees. The approval and reflection unit identifies a DOM node corresponding to the new arrival section of the top page using a search algorithm. The approval and reflection unit dynamically inserts nodes of the link and the introduction text of the new product as child elements of the identified node. The approval and reflection unit transmits an API request to a related product recommendation engine. The recommendation engine executes a collaborative filtering algorithm to calculate a list of existing products having a high degree of similarity to the new product. The approval and reflection unit updates a DOM tree of the related product page based on a calculation result. The approval and reflection unit automatically constructs a header node including SEO metadata and inserts it into each page. The approval and reflection unit serializes all the updated abstract syntax trees into a string source code. The approval and reflection unit deploys the serialized code to a web server in a production environment. The system combines node operation at an abstract syntax tree level and dynamic cooperation of the recommendation engine. The system autonomously and consistently updates related pages of the entire site triggered by a single page update. This process completely prevents manual link update omissions. This process exhibits a technical effect of improving a site circulation rate and an evaluation from a search engine. This configuration is applied to a large-scale EC platform in which the number of product items is enormous and mutual links between pages are complicatedly intertwined.

The backup management unit automatically saves a set of current mail-order site pages as a backup before executing an update operation, saves all related files such as HTML files, CSS files, JavaScript files, image files, PDF materials, video files, and setting files for external service cooperation with time information, and performs past version management. Thereby, even if a defect occurs after the update in an emergency, it can be restored to an original state with one click. All update histories are recorded, and who made what kind of change and when can be confirmed from a management screen. Specifically, in this use case, the backup management unit temporarily blocks an IO operation using a hook mechanism of a file system immediately before a deployment process. The backup management unit creates a snapshot of an entire target directory in a millisecond order using a logical volume manager. The backup management unit applies a cryptographic hash function to each file in the snapshot to calculate a checksum. The backup management unit registers a pair of the calculated checksum and a file path in an index database. The backup management unit asynchronously transfers snapshot data to a distributed storage cluster in a background process. The backup management unit releases the IO block after the transfer is completed. When receiving a restoration request from the management screen, the backup management unit searches the index database for a corresponding checksum. The backup management unit downloads a target data block in parallel from the distributed storage cluster. The backup management unit reconstructs the file on a memory and writes it back to the file system. The system combines the snapshot by the logical volume manager and the asynchronous transfer. The system makes a service stop time of a production environment due to a backup process substantially zero. The system reliably detects data corruption and falsification by integrity verification using the checksum. This process brings about a technical effect of satisfying an operation requirement of an enterprise system requiring extremely high reliability and availability. This configuration is applied to a mission-critical online service in which downtime directly leads to an opportunity loss.

Also, for example, when adding a question “How long is the warranty period?” and an answer “It is one year from the date of purchase” to an FAQ, a prompt text “Please add a question ‘How long is the warranty period?’ and an answer ‘It is one year from the date of purchase’ to the FAQ. Please create a draft with a Q&A format and a diagram” is read into the generative AI. The generative AI refers to expressions and diagram examples of existing FAQs to automatically generate a plurality of drafts, and the FAQ page is automatically updated by the person in charge selecting, modifying, and approving a draft. Specifically, in this use case, the generative AI processing unit vectorizes the input prompt text using a natural language processing model. The generative AI processing unit similarly vectorizes all text data in an existing FAQ database and holds it on a memory. The generative AI processing unit calculates a cosine similarity matrix between an input vector and an existing FAQ vector group. The generative AI processing unit determines whether an existing question having a similarity exceeding a predetermined threshold exists. When determining that there is no duplication, the generative AI processing unit activates a decoder layer of a transformer model. The decoder layer extracts a structural pattern of a Q&A format of past FAQs from a trained weight parameter. The decoder layer generates an HTML markup of a new question and answer in accordance with the extracted pattern. The generative AI processing unit inputs an answer text to a diagram generation module. The diagram generation module analyzes a semantic structure of the text and automatically generates an SVG code of corresponding vector graphics. The system mathematically eliminates semantic duplication by similarity calculation in a vector space. The system executes a multimodal output pipeline that links text generation and SVG code generation. This process exhibits a technical effect of automatically constructing visually easy-to-understand content while preventing information contradiction in the site. This configuration is applied to a self-resolution type help center system aiming at reducing a load of customer support.

In this way, the system of the present invention can realize page update quickly and safely while maintaining quality and consistency of the entire site, while flexibly responding to selection and additional instructions by the person in charge, by the generative AI utilizing past know-how and guidelines to automatically generate a plurality of high-quality update drafts just by the person in charge inputting a desire in a natural language. Specifically, the system completely replaces design conception, coding, testing, and deployment operations, which are human mental processes, with physical calculation processes of a computer. The system executes a mapping operation to a high-dimensional vector space by a natural language processing model. The system executes a matrix multiplication operation of billions of parameters based on a transformer architecture. The system executes a dependency resolution algorithm based on graph theory. The system constructs a pipeline integrating these advanced computer science techniques. The system converts a website update operation that has depended on person-dependent skills into a deterministic and scalable information processing process. The system improves a processing speed by thousands of times compared to human manual work by utilizing a parallel computing cluster and hardware acceleration. The system mathematically brings an occurrence rate of syntax errors and broken links close to zero by abstract syntax tree operation and atomic transaction management. The system guarantees complete data integrity and an audit trail by hash-based version management. This process brings about a technical effect of fundamentally improving data processing efficiency, storage utilization efficiency, and network communication efficiency of the computer system itself beyond mere business automation. This configuration is applied to a next-generation digital experience platform that achieves both agile information dissemination and robust system operation in a rapidly changing market environment.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL:https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

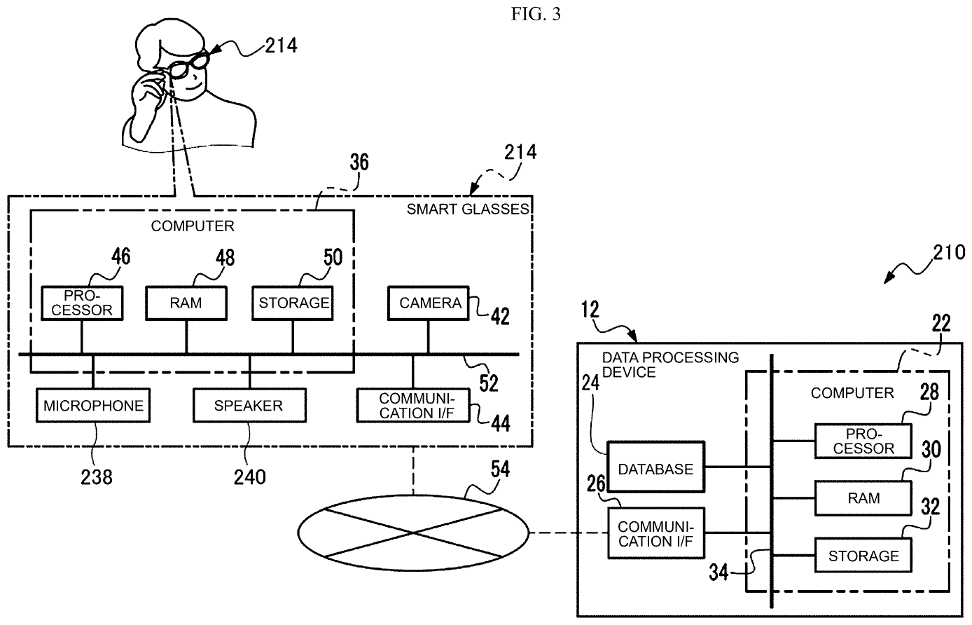

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

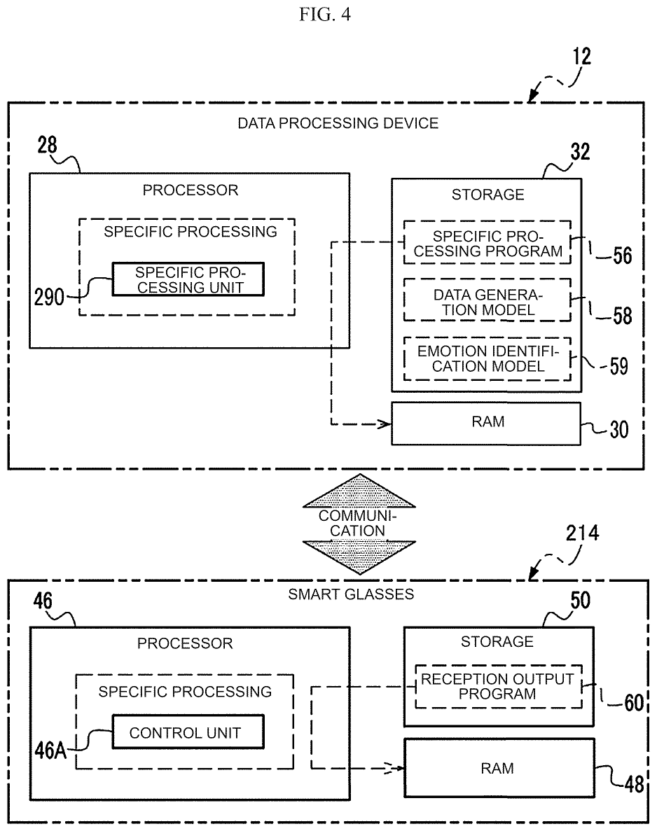

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

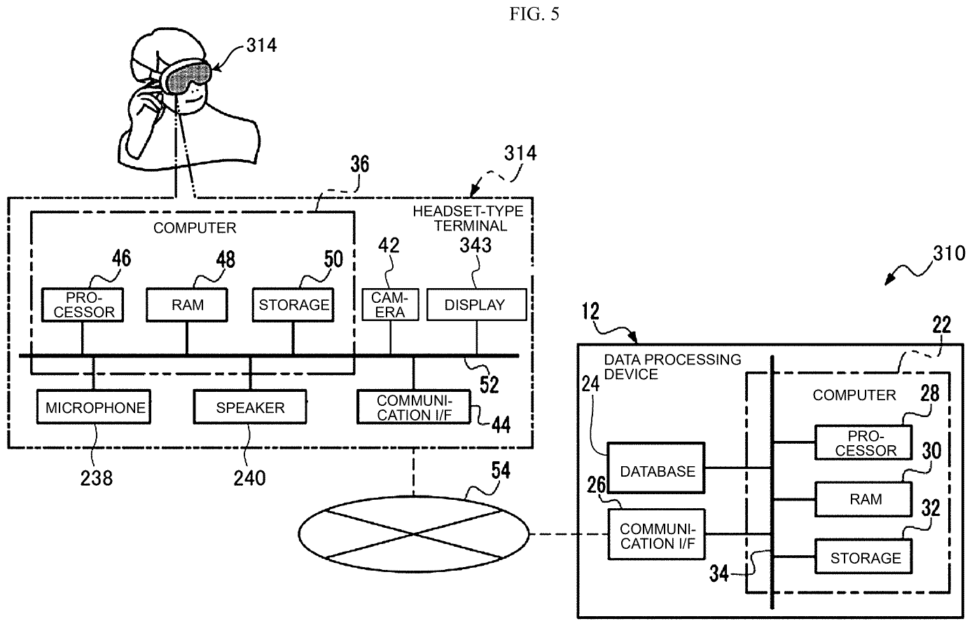

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

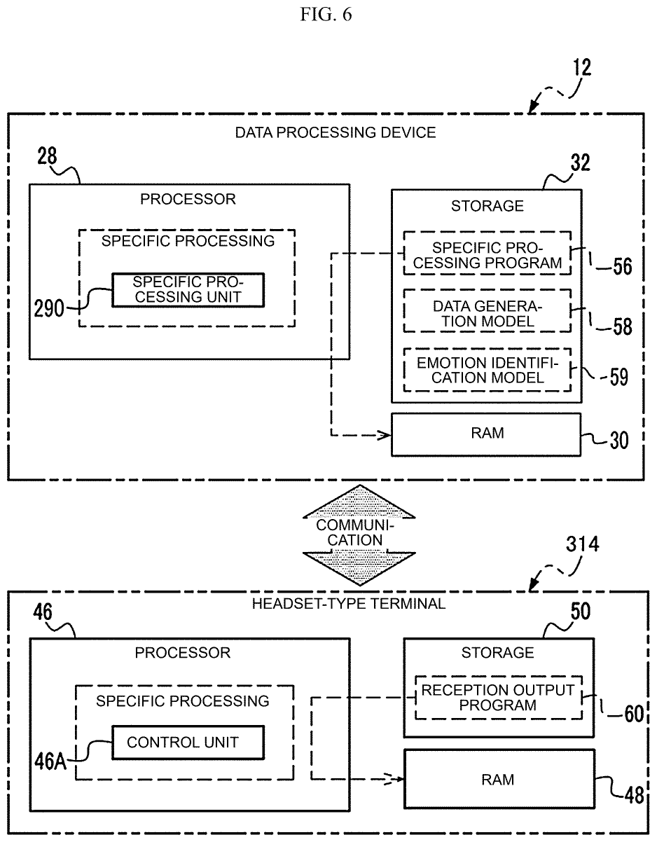

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

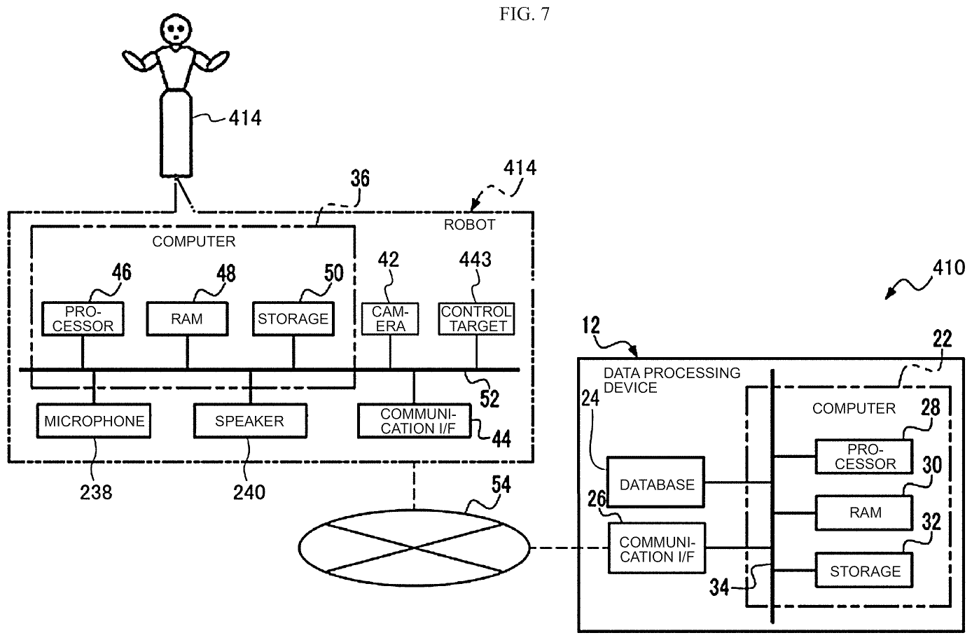

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

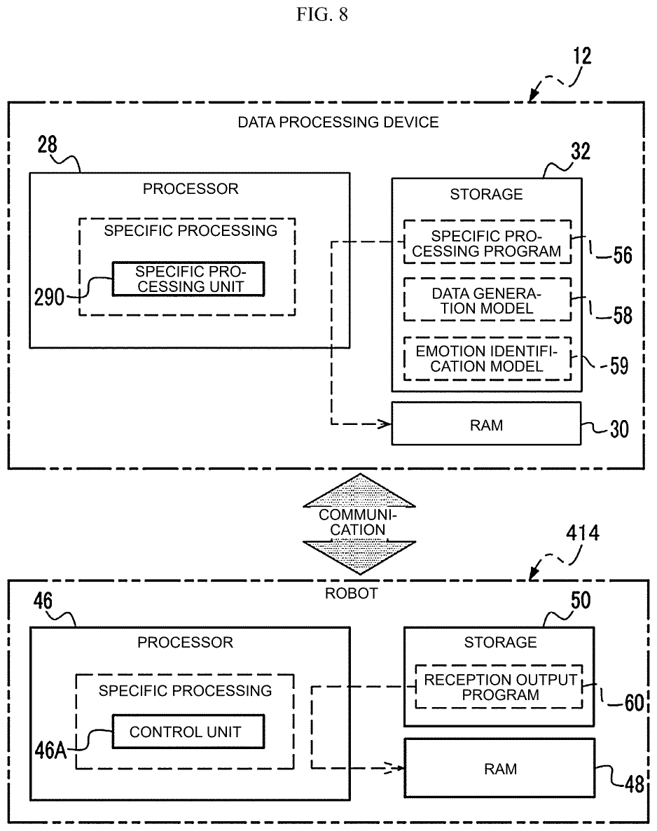

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.” (Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

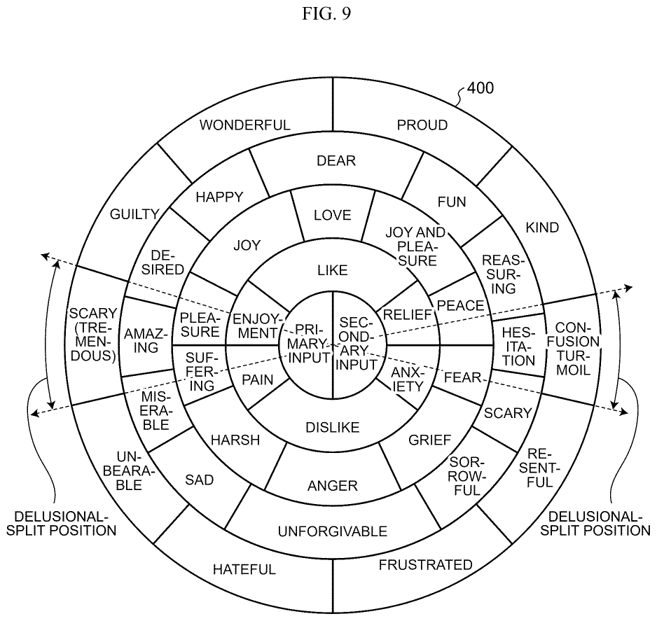

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

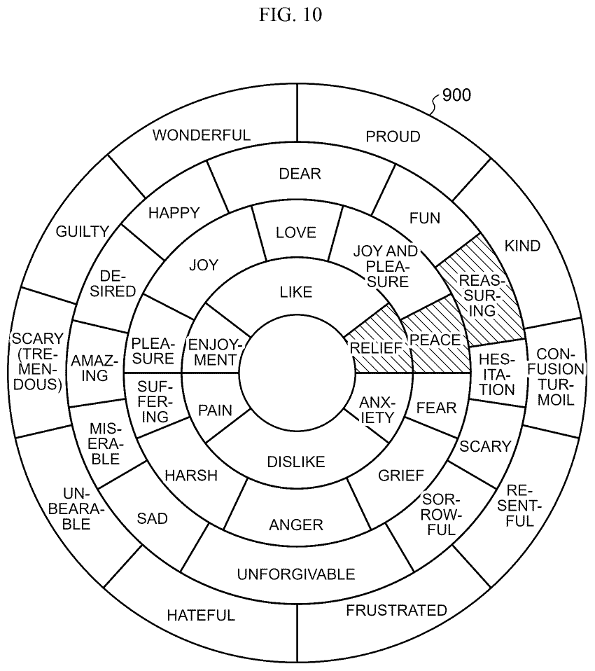

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A system comprising: a user input unit; a site information acquisition unit; a generative AI processing unit; a draft presentation unit; an approval and reflection unit; and a backup management unit, wherein the user input unit has a function of receiving desired content such as new product addition, sale information posting, FAQ update, and delivery guide modification from a person in charge of operating a mail-order site in a natural language, the site information acquisition unit automatically collects related information such as past HTML, CSS, and JavaScript files of the mail-order site, a product database, a campaign history, FAQ data, delivery guide data, a design guideline, a brand color, a font specification, an image material, a banner template, and an expression tone manual, the generative AI processing unit automatically generates a plurality of mail-order site update drafts using the desired content received from the user input unit and the information acquired by the site information acquisition unit by utilizing generative AI, the draft presentation unit presents the plurality of update drafts generated by the generative AI processing unit to the person in charge as preview images or HTML files, and receives a selection or an additional instruction by the person in charge, the approval and reflection unit automatically reflects the update draft selected or modified by the person in charge in an existing mail-order site page, and the backup management unit automatically saves the mail-order site page before update to enable restoration, wherein a series of these processes is realized using generative AI.

### Supplementary Note 2

The system according to Supplementary Note 1, wherein the generative AI processing unit analyzes the desired content in the natural language received from the user input unit to identify which element of which page of the mail-order site is to be changed and how, and generates the plurality of mail-order site update drafts automatically inheriting a brand image, a design rule, and an expression tone based on past site data and the guideline acquired by the site information acquisition unit, and the draft presentation unit presents the drafts to the person in charge in a preview format so that the person in charge can select an optimal draft or input an additional instruction.

### Supplementary Note 3

The system according to Supplementary Note 1, wherein when the approval and reflection unit automatically reflects the update draft approved by the person in charge in a corresponding portion of the existing mail-order site page, the generative AI processing unit analyzes existing HTML, CSS, and JavaScript files to safely rewrite only a necessary portion, and the backup management unit automatically saves the file before update, records an update history, and enables restoration to an original state in an emergency.

What is claimed is:

1. A system comprising:
circuitry configured to:
receive, via a communication interface coupled to a packet-switched network, content update specification data from a terminal device comprising natural language description text and optionally image data or file attachments, and store the content update specification data in a storage device;
retrieve reference document records from the storage device comprising historical content files, version history records, design template records, and style guideline records, and apply a natural language processing model to generate a content embedding vector from the content update specification data;
apply a generative neural network model to the content update specification data, the retrieved reference document records, and a set of candidate template records to generate a plurality of draft content data records each representing a distinct implementation of the content update specification; and
present the plurality of draft content data records to the terminal device via the communication interface, receive a selection input or a modification instruction from the terminal device, and apply the selected or modified draft content data record to update a target content file stored in the storage device.

2. The system according to claim 1, wherein the circuitry is configured to receive audio waveform data from the terminal device via the communication interface, apply a speech recognition model to convert the audio waveform data into text content, and incorporate the converted text content into the content update specification data as a natural language description field.

3. The system according to claim 1, wherein the circuitry is configured to receive image data from the terminal device via the communication interface, apply a convolutional neural network to the image data to extract image feature vectors comprising color distribution data, object detection labels, and layout structure data, and incorporate the image feature vectors as additional specification parameters in the content update specification data.

4. The system according to claim 1, wherein the circuitry is configured to store the target content file in a version history data structure prior to applying the update, assign a version identifier to the pre-update content file, and enable restoration to a prior version by retrieving the corresponding version identifier record from the storage device in response to a rollback request received from the terminal device.

5. The system according to claim 1, wherein the circuitry is configured to apply a multi-stage retrieval process to the reference document records by computing cosine similarity scores between the content embedding vector and reference document record embedding vectors indexed in a vector database, selecting the highest-ranked reference document records, and incorporating the selected records into the generative neural network model prompt as context.

6. The system according to claim 5, wherein the circuitry is configured to retrieve historical content files from previous update cycles by cosine similarity search, rank the retrieved files by update recency and relevance score, and incorporate the top-ranked historical content files as style reference context in the generative neural network model prompt.

7. The system according to claim 1, wherein the circuitry is configured to apply a style consistency evaluation model to each generated draft content data record by computing a style compatibility score between the draft and the design template records, filter out drafts having style compatibility scores below a minimum threshold, and rank remaining draft content data records in descending order of style compatibility score.

8. The system according to claim 7, wherein the circuitry is configured to apply a readability evaluation model to the text content in each draft content data record to compute a readability score, incorporate the readability score as an additional ranking factor alongside the style compatibility score, and present the top-ranked draft content data records to the terminal device.

9. The system according to claim 1, wherein the circuitry is configured to receive a modification instruction from the terminal device comprising natural language text describing desired changes to a selected draft content data record, apply the generative neural network model to the modification instruction and the selected draft to generate a revised draft content data record, and transmit the revised draft content data record to the terminal device.

10. The system according to claim 1, wherein the circuitry is configured to apply a validation pipeline to the updated target content file by checking structural conformance against markup schema rules, verifying link integrity, and validating media file formats and dimensions, and transmit a validation report to the terminal device identifying any conformance violations.

11. The system according to claim 1, wherein the circuitry is configured to transmit an approval request data record to a designated approver terminal device via the communication interface when the updated target content file is ready for publication, receive an approval response, and execute publication of the updated content file to a content serving endpoint only upon receipt of an approval response associated with an authorized approver user identifier.

12. The system according to claim 1, wherein the circuitry is configured to distribute the generative neural network model inference across a plurality of computing nodes using a container orchestration platform, scale inference resources based on incoming request load, and route high-priority requests to dedicated inference nodes.

13. The system according to claim 1, wherein the circuitry is configured to generate performance metric data by collecting access log data from the content serving endpoint via the communication interface, apply the natural language processing model to the collected access log data to extract user engagement signals, and generate an insight report suggesting content update themes based on the user engagement signals.

14. The system according to claim 1, wherein the circuitry is configured to store all content update specification data, draft content data records, selection inputs, and version history records in an audit log data structure with timestamps and user identifiers for compliance and review purposes.

15. The system according to claim 1, wherein the circuitry is configured to update the generative neural network model by generating training pairs from historical content update specification data records and corresponding validated draft content data records selected by users, and fine-tune the model to improve draft quality scores for specific content update specification patterns.

16. The system according to claim 1, wherein the circuitry is configured to apply a multilingual processing pipeline when the content update specification data is received in a non-system language by applying a machine translation model to generate translated specification text, and generate draft content data records in the target language specified by a locale parameter.

17. The system according to claim 1, wherein the content update specification data describes desired changes to a structured web document, the reference document records comprise prior version content files and design templates, and the draft content data records represent distinct implementations of the specified changes formatted for the target content file structure.

18. A system comprising:
circuitry configured to:
receive, via a communication interface coupled to a packet-switched network, content update specification data from a terminal device;
retrieve reference document records and apply a natural language processing model to generate a content embedding vector for similarity-based reference retrieval;
apply a generative neural network model to generate a plurality of draft content data records, apply style consistency and readability evaluation models to rank and filter drafts;
present draft content data records to the terminal device, receive selection or modification inputs, and apply the selected draft to update a target content file with version history preservation; and
apply a validation pipeline and transmit the updated content file to a content serving endpoint upon receipt of an approver confirmation.

19. The system according to claim 18, wherein the circuitry is configured to receive modification instructions as natural language text and apply the generative neural network model to generate revised draft content data records, collect access log data from the content serving endpoint to extract user engagement signals, and generate insight reports suggesting content update themes.

20. A method comprising:
receiving, via a communication interface coupled to a packet-switched network, content update specification data from a terminal device, and storing the content update specification data in a storage device;
retrieving reference document records and applying a natural language processing model to generate a content embedding vector;
applying a generative neural network model to generate a plurality of draft content data records each representing a distinct implementation of the content update specification;
presenting the draft content data records to the terminal device, receiving a selection input or modification instruction, and applying the selected draft to update a target content file; and
storing the pre-update content file in a version history data structure prior to applying the update.
